(19) United States
(12) Patent Application Publication
(10) Pub. No.: US 2012/0248078 A1
(43) Pub. Date: Oct. 4, 2012

(54) CONTROL SYSTEM FOR HIGH POWER LASER DRILLING WORKOVER AND COMPLETION UNIT

(76) Inventors: Mark S. Zediker, Castle Rock, CO (US); Siamak Makki, Novato, CA (US); Brian O. Faircloth, Evergreen, CO (US); Ronald A. DeWitt, Katy, TX (US); Erik C. Allen, Minneapolis, MN (US); Lance D. Underwood, Morrison, CO (US)

(21) Appl. No.: 13/403,692

(22) Filed: Feb. 23, 2012

Related U.S. Application Data
(63) Continuation-in-part of application No. 13/210,581, filed on Aug. 16, 2011.
Application No. 13/210,581 is a continuation-in-part of application No. 12/544,136, filed on Aug. 19, 2009.
Application No. 12/544,136 is a continuation-in-part of application No. 12/544,136, filed on Aug. 19, 2009.
Application No. 12/544,136 is a continuation-in-part of application No. 12/543,986, filed on Aug. 19, 2009.
(60) Provisional application No. 61/446,412, filed on Feb. 24, 2011.
(60) Provisional application No. 61/446,312, filed on Feb. 24, 2011.
(60) Provisional application No. 61/446,407, filed on Feb. 24, 2011.
(60) Provisional application No. 61/153,271, filed on Feb. 17, 2009.
(60) Provisional application No. 61/106,472, filed on Oct. 17, 2008.
(60) Provisional application No. 61/102,730, filed on Oct. 3, 2008.
(60) Provisional application No. 61/090,384, filed on Aug. 20, 2008.
(60) Provisional application No. 61/153,271, filed on Feb. 17, 2009.
(60) Provisional application No. 61/106,472, filed on Oct. 17, 2008.
(60) Provisional application No. 61/102,730, filed on Oct. 3, 2008.
(60) Provisional application No. 61/090,384, filed on Aug. 20, 2008.
(60) Provisional application No. 61/153,271, filed on Feb. 17, 2009.
(60) Provisional application No. 61/106,472, filed on Oct. 17, 2008.
(60) Provisional application No. 61/102,730, filed on Oct. 3, 2008.
(60) Provisional application No. 61/090,384, filed on Aug. 20, 2008.
(60) Provisional application No. 61/446,042, filed on Feb. 24, 2011.

(51) Int. Cl. B23K 26/16

(52) U.S. Cl. 219/121.67

(57) ABSTRACT

There is provided a control, monitoring, and control and monitoring system for controlling and monitoring a high power laser system for performing high power laser operations and, in particular, for performing high power laser operation on, and in, remote and difficult to access locations.

This application: (i) claims, under 35 U.S.C. §119(e)(1), the benefit of the filing date of Feb. 24, 2011 of U.S. provisional application Ser. No. 61/446,412; (ii) claims, under 35 U.S.C. §119(e)(1), the benefit of the filing date of Feb. 24, 2011 of U.S. provisional application Ser. No. 61/446,312; (iii) claims, under 35 U.S.C. §119(e)(1), the benefit of the filing date of Feb. 24, 2011 of U.S. provisional application Ser. No. 61/446,407; (iv) is a continuation-in-part of US patent application Ser. No. 13/210,581 filed Aug. 16, 2011, which is a continuation-in-part of U.S. patent application Ser. No. 12/544,136 filed Aug. 19, 2009, which claims under 35 U.S.C. §119(e)(1) the benefit of the filing date of Feb. 17, 2009 of U.S. provisional application Ser. No. 61/153,271, the benefit of the filing date of Oct. 17, 2008 of U.S. provisional application Ser. No. 61/106,472, the benefit of the filing date of Oct. 3, 2008 of U.S. provisional application Ser. No. 61/102,730, and the benefit of the filing date of Aug. 20, 2008 of U.S. provisional application Ser. No. 61/090,384; (v) is a continuation-in-part of U.S. patent application Ser. No. 12/544,136 filed Aug. 19, 2009, which claims under 35 U.S.C. §119(e)(1) the benefit of the filing date of Feb. 17, 2009 of U.S. provisional application Ser. No. 61/153,271, the benefit of the filing date of Oct. 17, 2008 of U.S. provisional application Ser. No. 61/106,472, the benefit of the filing date of Oct. 3, 2008 of U.S. provisional application Ser. No. 61/102,730, and the benefit of the filing date of Aug. 20, 2008 of U.S. provisional application Ser. No. 61/090,384; (vi) is a continuation-in-part of U.S. patent application Ser. No. 12/543,986 filed Aug. 19, 2009, which claims under 35 U.S.C. §119(e)(1) the benefit of the filing date of Feb. 17, 2009 of U.S. provisional application Ser. No. 61/153,271, the benefit of the filing date of Oct. 17, 2008 of U.S. provisional application Ser. No. 61/106,472, the benefit of the filing date of Oct. 3, 2008 of U.S. provisional application Ser. No. 61/102,730, and the benefit of the filing date of Aug. 20, 2008 of U.S. provisional application Ser. No. 61/090,384; and, (vii) claims, under 35 U.S.C. §119(e)(1), the benefit of the filing date of Feb. 24, 2011 of U.S. provisional application Ser. No. 61/446,042, the entire disclosures of each of which are incorporated herein by reference.

This invention was made with Government support under Award DE-AR0000044 awarded by the Office of ARPA-E U.S. Department of Energy. The Government has certain rights in this invention.

### BACKGROUND OF THE INVENTION

### Field of the Invention

The present inventions relate to high power laser systems and units and high power laser-mechanical tools systems and units, such as for example drilling, workover and completion, perforating, decommissioning, cleaning, mining, and laser pigging units; and, in particular to control systems and monitoring systems for high power laser systems and units.

As used herein, unless specified otherwise “high power laser energy” means a laser beam having at least about 1 kW (kilowatt) of power. As used herein, unless specified otherwise “great distances” means at least about 500 m (meter). As used herein, unless specified otherwise, the term “substantial loss of power,” “substantial power loss” and similar such phrases, mean a loss of power of more than about 3.0 dB/km (decibel/kilometer) for a selected wavelength. As used herein, unless specified otherwise, the term “substantial power transmission” means at least about 50% transmittance.

As used herein the term “pipeline” should be given its broadest possible meaning, and includes any structure that contains a channel having a length that is many orders of magnitude greater than its cross-sectional area and which is for, or capable of, transporting a material along at least a portion of the length of the channel. Pipelines may be many miles long and may be many hundreds of miles long. Pipelines may be located below the earth, above the earth, under water, within a structure, or combinations of these and other locations. Pipelines may be made from metal, steel, plastics, ceramics, composite materials, or other materials and compositions know to the pipeline arts and may have external and internal coatings, known to the pipeline arts. In general, pipelines may have internal diameters that range from about 2 to about 60 inches although larger and smaller diameters may be utilized. In general natural gas pipelines may have internal diameters ranging from about 2 to 60 inches and oil pipelines have internal diameters ranging from about 4 to 48 inches. Pipelines may be used to transmit numerous types of materials, in the form of a liquid, gas, fluidized solid, slurry or combinations thereof. Thus, for example pipelines may carry hydrocarbons; chemicals; oil; petroleum products; gasoline; ethanol; biofuels; water; drinking water; irrigation water; cooling water; water for hydroelectric power generation; water, or other fluids for geothermal power generation; natural gas; paints; slurries, such as mineral slurries, coal slurries, pulp slurries; and ore slurries; gases, such as nitrogen and hydrogen; cosmetics; pharmaceuticals; and food products, such as beer.

Pipelines may be, in part, characterized as gathering pipelines, transportation pipelines and distribution pipelines, although these characterizations may be blurred and may not cover all potential types of pipelines. Gathering pipelines are a number of smaller interconnected pipelines that form a network of pipelines for bringing together a number of sources, such as for example bringing together hydrocarbons being produced from a number of wells. Transportation pipelines are what can be considered as a traditional pipeline for moving products over longer distances for example between two cities, two countries, and a production location and a shipping, storage or distribution location. The Alaskan oil pipeline is an example of a transportation pipeline. Distribution pipelines can be small pipelines that are made up of several interconnected pipelines and are used for the distribution to for example an end user, of the material that is being delivered by the pipeline, such as for example the feeder lines used to provide natural gas to individual homes. As used herein the term pipeline includes all of these and other characterizations of pipelines that are known to or used in the pipeline arts.

As used herein the term “pig” is to be given its broadest possible meaning and includes all devices that are known as or referred to in the pipeline arts as a “pig” and would include any device that is inserted into and moved along at least a portion of the length of a pipeline to perform activities such as inspecting, cleaning, measuring, analyzing, maintaining, welding, assembling, or other activities known to the pipeline arts. In general, pigs are devices that may be unitary devices, as simple as a foam or metal ball, or a complex multi-component device such as a magnetic flux leakage pig. In general, pigs are devices that when inserted in the pipeline travel along its length and are moved through the pipeline by the flow of the material within the pipe. Pigs may generally be characterized as utility and in-line inspection pigs, although these characterizations may be blurred and may not cover all potential types of pigs. Utility pigs perform such functions as for example cleaning, separation of products and removal of water. In-line inspection pigs, would include gauge pigs, as well as, more complex pigs, which may also be referred to by those of skill in the art as instrument pigs, intelligent pigs or smart pigs. Smart pigs perform such functions as for example supplying information on the condition of the pipeline, as well as on the extent and location of any problems with the pipeline. Pigs are used both during the construction and during the operational life of the pipelines. Pigs may also be used in the decommissioning of a pipeline and its removal.

As used herein, unless specified otherwise, the term “earth” should be given its broadest possible meaning, and includes, the ground, all natural materials, such as rocks, and artificial materials, such as concrete, that are or may be found in the ground, including without limitation rock layer formations, such as, granite, basalt, sandstone, dolomite, sand, salt, limestone, rhyolite, quartzite and shale rock.

As used herein, unless specified otherwise, the term “borehole” should be given it broadest possible meaning and includes any opening that is created in a material, a work piece, a surface, the earth, a structure (e.g., building, protected military installation, nuclear plant, offshore platform, or ship), or in a structure in the ground, (e.g., foundation, roadway, airstrip, cave or subterranean structure) that is substantially longer than it is wide, such as a well, a well bore, a well hole, a micro hole, slimhole, a perforation and other terms commonly used or known in the arts to define these types of narrow long passages. Wells would further include exploratory, production, abandoned, reentered, reworked, and injection wells. Although boreholes are generally oriented substantially vertically, they may also be oriented on an angle from vertical, to and including horizontal. Thus, using a vertical line, based upon a level as a reference point, a borehole can have orientations ranging from 0° i.e., vertical, to 90°,i.e., horizontal and greater than 90° e.g., such as a heel and toe and combinations of these such as for example “U” and “Y” shapes. Boreholes may further have segments or sections that have different orientations, they may have straight sections and arcuate sections and combinations thereof; and for example may be of the shapes commonly found when directional drilling is employed. Thus, as used herein unless expressly provided otherwise, the “bottom” of a borehole, the “bottom surface” of the borehole and similar terms refer to the end of the borehole, i.e., that portion of the borehole furthest along the path of the borehole from the borehole's opening, the surface of the earth, or the borehole's beginning. The terms “side” and “wall” of a borehole should to be given their broadest possible meaning and include the longitudinal surfaces of the borehole, whether or not casing or a liner is present, as such, these terms would include the sides of an open borehole or the sides of the casing that has been positioned within a borehole. Boreholes may be made up of a single passage, multiple passages, connected passages and combinations thereof, in a situation where multiple boreholes are connected or interconnected each borehole would have a borehole bottom. Boreholes may be formed in the sea floor, under bodies of water, on land, in ice formations, or in other locations and settings.

Boreholes are generally formed and advanced by using mechanical drilling equipment having a rotating drilling tool, e.g., a bit. For example and in general, when creating a borehole in the earth, a drilling bit is extending to and into the earth and rotated to create a hole in the earth. In general, to perform the drilling operation the bit must be forced against the material to be removed with a sufficient force to exceed the shear strength, compressive strength or combinations thereof, of that material. Thus, in conventional drilling activity mechanical forces exceeding these strengths of the rock or earth must be applied. The material that is cut from the earth is generally known as cuttings, e.g., waste, which may be chips of rock, dust, rock fibers and other types of materials and structures that may be created by the bit's interactions with the earth. These cuttings are typically removed from the borehole by the use of fluids, which fluids can be liquids, foams or gases, or other materials know to the art.

As used herein, unless specified otherwise, the term “advancing” a borehole should be given its broadest possible meaning and includes increasing the length of the borehole. Thus, by advancing a borehole, provided the orientation is not horizontal, e.g., less than 90° the depth of the borehole may also be increased. The true vertical depth (“TVD”) of a borehole is the distance from the top or surface of the borehole to the depth at which the bottom of the borehole is located, measured along a straight vertical line. The measured depth (“MD”) of a borehole is the distance as measured along the actual path of the borehole from the top or surface to the bottom. As used herein unless specified otherwise the term depth of a borehole will refer to MD. In general, a point of reference may be used for the top of the borehole, such as the rotary table, drill floor, well head or initial opening or surface of the structure in which the borehole is placed.

As used herein, unless specified otherwise, the terms “ream”, “reaming”, a borehole, or similar such terms, should be given their broadest possible meaning and includes any activity performed on the sides of a borehole, such as, e.g., smoothing, increasing the diameter of the borehole, removing materials from the sides of the borehole, such as e.g., waxes or filter cakes, and under-reaming.

As used herein, unless specified otherwise, the terms “drill bit”, “bit”, “drilling bit” or similar such terms, should be given their broadest possible meaning and include all tools designed or intended to create a borehole in an object, a material, a work piece, a surface, the earth or a structure including structures within the earth, and would include bits used in the oil, gas and geothermal arts, such as fixed cutter and roller cone bits, as well as, other types of bits, such as, rotary shoe, drag-type, fishtail, adamantine, single and multi-toothed, cone, reaming cone, reaming, self-cleaning, disc, three-cone, rolling cutter, crossroller, jet, core, impreg and hammer bits, and combinations and variations of the these.

In general, in a fixed cutter bit there are no moving parts. In these bits drilling occurs when the entire bit is rotated by, for example, a rotating drill string, a mud motor, or other means to turn the bit. Fixed cutter bits have cutters that are attached to the bit. These cutters mechanically remove material, advancing the borehole as the bit is turned. The cutters in fixed cutter bits can be made from materials such as polycrystalline diamond compact (“PDC”), grit hotpressed inserts (“GHI”), and other materials known to the art or later developed by the art.

In general, a roller cone bit has one, two, three or more generally conically shaped members, e.g., the roller cones, that are connected to the bit body and which can rotate with respect to the bit. Thus, as the bit is turned, and the cones contact the bottom of a borehole, the cones rotate and in effect roll around the bottom of the borehole. In general, the cones have, for example, tungsten carbide inserts (“TCI”) or milled teeth (“MT”), which contact the bottom, or other surface, of the borehole to mechanically remove material and advance the borehole as the bit it turned.

In both roller cone, fixed bits, and other types of mechanical drilling the state of the art, and the teachings and direction of the art, provide that to advance a borehole great force should be used to push the bit against the bottom of the borehole as the bit is rotated. This force is referred to as weight-on-bit (“WOB”). Typically, tens of thousands of pounds WOB are used to advance a borehole using a mechanical drilling process.

Mechanical bits cut rock by applying crushing (compressive) and/or shear stresses created by rotating a cutting surface against the rock and placing a large amount of WOB. In the case of a PDC bit this action is primarily by shear stresses and in the case of roller cone bits this action is primarily by crushing (compression) and shearing stresses. For example, the WOB applied to an 8¾″ PDC bit may be up to 15,000 lbs, and the WOB applied to an 8¾″ roller cone bit may be up to 60,000 lbs. When mechanical bits are used for drilling hard and ultra-hard rock excessive WOB, rapid bit wear, and long tripping times result in an effective drilling rate that is essentially economically unviable. The effective drilling rate is based upon the total time necessary to complete the borehole and, for example, would include time spent tripping in and out of the borehole, as well as, the time for repairing or replacing damaged and worn bits.

As used herein, unless specified otherwise, the term “drill pipe” should be given its broadest possible meaning and includes all forms of pipe used for drilling activities; and refers to a single section or piece of pipe, as well as, multiple pipes or sections. As used herein, unless specified otherwise, the terms “stand of drill pipe,” “drill pipe stand,” “stand of pipe,” “stand” and similar type terms should be given their broadest possible meaning and include two, three or four sections of drill pipe that have been connected, e.g., joined together, typically by joints having threaded connections. As used herein, unless specified otherwise, the terms “drill string,” “string,” “string of drill pipe,” string of pipe” and similar type terms should be given their broadest definition and would include a stand or stands joined together for the purpose of being employed in a borehole. Thus, a drill string could include many stands and many hundreds of sections of drill pipe.

As used herein, unless specified otherwise, the term “tubular” should be given its broadest possible meaning and includes drill pipe, casing, riser, coiled tube, composite tube, vacuum insulated tubing (“VIT”), production tubing and any similar structures having at least one channel therein that are, or could be used, in the drilling industry. As used herein the term “joint” should be given its broadest possible meaning and includes all types of devices, systems, methods, structures and components used to connect tubulars together such as for example, threaded pipe joints and bolted flanges. For drill pipe joints, the joint section typically has a thicker wall than the rest of the drill pipe. As used herein the thickness of the wall of tubular is the thickness of the material between the internal diameter of the tubular and the external diameter of the tubular.

As used herein, unless specified otherwise the terms “blowout preventer,” “BOP,” and “BOP stack” should be given their broadest possible meaning, and include: (i) devices positioned at or near the borehole surface, e.g., the surface of the earth including dry land or the seafloor, which are used to contain or manage pressures or flows associated with a borehole; (ii) devices for containing or managing pressures or flows in a borehole that are associated with a subsea riser or a connector; (iii) devices having any number and combination of gates, valves or elastomeric packers for controlling or managing borehole pressures or flows; (iv) a subsea BOP stack, which stack could contain, for example, ram shears, pipe rams, blind rams and annular preventers; and, (v) other such similar combinations and assemblies of flow and pressure management devices to control borehole pressures, flows or both and, in particular, to control or manage emergency flow or pressure situations.

As used herein, unless specified otherwise “offshore” and “offshore drilling activities” and similar such terms are used in their broadest sense and would include drilling activities on, or in, any body of water, whether fresh or salt water, whether manmade or naturally occurring, such as for example rivers, lakes, canals, inland seas, oceans, seas, bays and gulfs, such as the Gulf of Mexico. As used herein, unless specified otherwise the term “offshore drilling rig” is to be given its broadest possible meaning and would include fixed towers, tenders, platforms, barges, jack-ups, floating platforms, drill ships, dynamically positioned drill ships, semi-submersibles and dynamically positioned semi-submersibles. As used herein, unless specified otherwise the term “seafloor” is to be given its broadest possible meaning and would include any surface of the earth that lies under, or is at the bottom of, any body of water, whether fresh or salt water, whether manmade or naturally occurring.

As used herein the terms “decommissioning,” “plugging” and “abandoning” and similar such terms should be given their broadest possible meanings and would include activities relating to the cutting and removal of casing and other tubulars from a well (above the surface of the earth, below the surface of the earth and both), modification or removal of structures, apparatus, and equipment from a site to return the site to a prescribed condition, the modification or removal of structures, apparatus, and equipment that would render such items in a prescribe inoperable condition, the modification or removal of structures, apparatus, and equipment to meet environmental, or regulatory considerations present at the end of such items useful, economical or intended life cycle. Such activities would include for example the removal of onshore, e.g., land based, structures above the earth, below the earth and combinations of these, such as e.g., the removal of tubulars from within a well in preparation for plugging. The removal of offshore structures above the surface of a body of water, below the surface, and below the seafloor and combinations of these, such as fixed drilling platforms, the removal of conductors, the removal of tubulars from within a well in preparation for plugging, the removal of structures within the earth, such as a section of a conductor that is located below the seafloor and combinations of these.

As used herein the terms “workover,” “completion” and “workover and completion” and similar such terms should be given their broadest possible meanings and would include activities that place at or near the completion of drilling a well, activities that take place at or the near the commencement of production from the well, activities that take place on the well when the well is producing or operating well, activities that take place to reopen or reenter an abandoned or plugged well or branch of a well, and would also include for example, perforating, cementing, acidizing, fracturing, pressure testing, the removal of well debris, removal of plugs, insertion or replacement of production tubing, forming windows in casing to drill or complete lateral or branch wellbores, cutting and milling operations in general, insertion of screens, stimulating, cleaning, testing, analyzing and other such activities. These terms would further include applying heat, directed energy, preferably in the form of a high power laser beam to heat, melt, soften, activate, vaporize, disengage, desiccate and combinations and variations of these, materials in a well, or other structure, to remove, assist in their removal, cleanout, condition and combinations and variation of these, such materials.

As used herein, unless specified otherwise, the term “unit” and “system” should be given its broadest possible meaning, and would include any device, apparatus or system, whether integral, modular or component based. As used herein a high power laser “unit” and a high power laser “system”, unless specified otherwise, would include any unit or system having a high power laser, having support equipment for a high power laser, having a high power conveyance device, and having a high power laser tool assembly. Thus, for example, high power laser units and high power laser systems may be land based, sea based, land and sea based, mobile, containerized, truck based, barge based, vessel based, rig based, fixed and combinations and variations thereof.

### SUMMARY

There is a need for a control system, a monitoring system and combinations of both for the operation of high power lasers units for use in activities involving the transmission of high power laser energy over great distance to high power laser tools to perform activities, such as for example, drilling, workover and completion activities in the oil, natural gas and geothermal industries, as well as, activities in other industries, such as the nuclear industry, the chemical industry, the subsea exploration, salvage and construction industry, the pipeline industry, and the military. In particular, such control and monitoring systems are needed when the high power laser energy is transmitted over great distances to small and/or difficult to access locations, positions or environments for activities such as monitoring, cleaning, controlling, assembling, drilling, machining and cutting. The present inventions, among other things, solve these and other needs by providing the articles of manufacture, devices and processes taught herein.

There is provided a system for controlling, operating, or monitoring, a high power laser unit having a source of high power laser energy, a high power optical conveyance device, a high power laser tool, wherein the high power optical conveyance device provides optical communication for a laser beam from the high power laser energy source to be conveyed to the high power laser tool, the system having: a control network having a first monitoring device, a second monitoring device; wherein the first monitoring devices is positioned with respect to a location on the unit to detect laser energy; wherein the second monitoring device is positioned with respect to a location on the unit to detect the status of a component of the unit; the first and second monitoring devices, in communication with a controller, wherein at least one of the monitoring devices can send a signal on the network; and, the controller is configured to act upon the signal from the monitoring device and performing a predetermined operation based upon the signal.

Moreover there is provided systems and units that may also include: where the component is a laser tool and the signal indicates the failure of the laser tool and the operation is sending a signal to shut down the high power laser source; where the signal is from the first or second monitoring device and the operation is to wait for a signal from the other monitoring device; wherein the first monitoring device comprises a photo diode and the second monitoring device comprises a load cell; wherein the component is a laser tool and the signal indicates the position of the tool; where the component is a laser bottom hole assembly having a bit and the signal indicates the RPM of the bit.

Still further there is provided a system for remotely deterring and monitoring the RPM of a down hole tool, the system having: an accelerometer positioned in vibrational communication with a member near the top of a borehole; the member in vibrational communication with a down hole tool as the tool is rotated to advance the borehole; the accelerometer configured to send a signal based upon vibrations associated with the rotation of the down hole tool; and a processor configured to convert the vibration signal to the RPM of the down hole tool as it is rotated to advance the borehole. This system may also have the RPM value utilized by a controller in the system to control the RPM of the down hole tool and it may further have the down hole tool being a laser bottom hole assembly.

Yet further, there is provided a control system for a high power laser unit for performing a laser operation at a remote location, the system and unit having: a first module in communication with a source of high power laser energy, the laser source capable of providing a laser beam having at least 5 kW of power; a second module in communication with a tubing assembly, the tubing assembly having: a tubing having a distal end and a proximal end, and a high power optical fiber having a distal end and a proximal end, wherein the high power optical fiber is associated with the tubing and the high power optical fiber distal end is associated with the tubing distal end; a third module in communication with a high power laser tool, the laser tool in optical association with the distal end of the high power fiber and in mechanical association with the distal end of the tubing; a fourth module in communication with a motive means, the motive means to advancing the distal end of the tubing to a predetermined worksite location; the proximal end of the optical fiber in optical association with the laser source, whereby the laser beam can be transmitted from the laser source to the laser tool; a fifth module in communication with a human machine interface; and, a control module in communication with the first, second, third, fourth and fifth modules; whereby, the control module is configured to send a control signal to send a control signal to at least one of the first, second, third, or fourth modules based upon a signal received from at least one of the first, second, third, fourth or fifth modules, to thereby control an operation of the unit.

Additionally, there is provided a control system for a high power laser unit for performing a laser operation at a remote location, the system and unit having: a first module in communication with a source of high power laser energy, the laser source capable of providing a laser beam having at least 5 kW of power; a second module in communication with a tubing assembly, the tubing assembly having: a tubing having a distal end and a proximal end, and a high power optical fiber having a distal end and a proximal end, wherein the high power optical fiber is associated with the tubing and the high power optical fiber distal end is associated with the tubing distal end; a third module in communication with a high power laser tool, the laser tool in optical association with the distal end of the high power fiber and in mechanical association with the distal end of the tubing; a fourth module in communication with a motive means, the motive means to advancing the distal end of the tubing to a predetermined worksite location; the proximal end of the optical fiber in optical association with the laser source, whereby the laser beam can be transmitted from the laser source to the laser tool; a fifth module in communication with a human machine interface; and, a control module in communication with the first, second, third, fourth and fifth modules; whereby, the control module is configured to send a control signal to send a control signal to at least one of the first, second, third, or fourth modules based upon a signal received from at least one of the first, second, third, fourth or fifth modules, to thereby control an operation of the unit. Such a unit may also include: the control module is associated with a programmable logic controller; the control module is associated with a personal computer; where the tubing is selected from the group including composite tubing, coiled tubing and wireline; wherein the optical fiber has a length selected from the group of length of about 0.5 km, about 1 km, about 2 km, about 3 km and from about 0.5 km to about 5 km; and wherein the laser tool is selected from the group including a laser cutting tool, a laser bottom hole assembly and an electric motor laser bottom hole assembly; where the first, third and control modules reside on a control network, the network and modules configured to send and receive data signals and control signals between the first, third and control modules; where the second, fourth and fifth modules reside on the control network and the network and modules configured to send and receive data signals and control signal between the second, fourth, fifth and control modules; or where a signal is received from the fifth module causing the control to send a signal to the third and fourth modules to stop operation of the tool, and retrieve the tool.

### BRIEF DESCRIPTION OF THE DRAWINGS

FIG. 1 is a schematic of the embodiment of the control and monitoring system for the high power laser drilling system of FIG. 4 in accordance with the present invention.

FIG. 1A is a schematic table for the control and monitoring system of FIG. 1.

FIG. 1B is a schematic of an embodiment of an advancement device associated with the control and monitoring system of FIG. 1.

FIGS. 1C to 1N are schematics of embodiments of components of the control and monitoring system of FIG. 1.

FIGS. 1O to 1R are drawings of embodiments of HMI displays in accordance with the present invention.

FIG. 2 is schematic view of an embodiment of a mobile laser truck unit in accordance with the present invention.

FIG. 2A is a schematic of an embodiment of a control and monitoring system for the unit of FIG. 2, in accordance with the present invention.

FIG. 2B is a schematic of the control and monitoring system of FIG. 2A.

FIG. 3 is a schematic view of an embodiment of a control and monitoring system in accordance with the present invention.

FIG. 4 is a schematic view of an embodiment of a high power laser system deployed in laser activities in the field in accordance with the present invention.

FIG. 5 is schematic view of an embodiment of a mobile truck laser unit for an electric motor laser bottom hole assembly (“EM-LBHA”) in accordance with the present invention.

FIG. 5A is a schematic of a distributed control system for the laser unit of FIG. 5.

FIG. 6 is a schematic view of an embodiment of laser unit as deployed and utilizing an EM-LBHA in accordance with the present invention.

### DESCRIPTION OF THE PREFERRED EMBODIMENTS

The present inventions relate to systems for delivering and utilization of high power laser energy, for example at least about 5 kW, at least about 10 kW, at least about 20 kW, at least about 50 kW, and at least about 100 kW. In particular, the present inventions relate to control and monitoring systems for high power laser units for performing activities such as drilling, working over, completing, cleaning, milling, perforating, monitoring, analyzing, cutting, removing, welding and assembling. More specifically, and by way of example, the present inventions relate to control and monitoring systems for high power energy drilling workover and completion units.

In general, a control and monitoring system for a high power laser unit or system, should preferably address primary functions, components and parameters, preferably key functions, components and parameters, and more preferably all critical functions, components and parameters of the laser unit, including such parameters, which are deemed critical when viewed from operations, productivity and combinations thereof perspective. The present inventions contemplate systems that address a single component, function or parameter, less than, or more than all critical components and parameters, only important components and parameters, more than or less than all important components and parameters, and combinations an variations of the foregoing.

It is also preferable that the control and monitoring system be fully integrated systems, such that control activities, monitoring activities and data retrieval activities are capable of being performed by a single integrated network, which may have varied individual controls, sensors, monitors and other equipment. A fully integrated system, a system having sub-systems, a system that is partially integrated, a system that is a distributed control network, a system that is a control network, and an independent system, and combinations and variations thereof, are also contemplated.

There are several functions, conditions, parameters and components that preferably should be monitored and controlled by a high power laser control and monitoring system. More, less or other components, functions, parameters and conditions, depending upon the particular unit, and also upon the particular application or utilization of the unit, may be monitored and controlled. Thus, by way of general examples, equipment, parameters, and conditions that could be monitored and controlled may include, one or more of the following:

Laser—such as laser operations, laser power output, temperature, back reflections, laser chiller, laser chiller status, laser readiness and laser status. This would include the use of multiple lasers, or laser having multiple modules, as well as, a separate laser unit, such as a laser truck which is later integrated or optically associated with for example a laser tool;

High power optical fiber—such as fiber integrity, break detection, temperature, back reflections, splices, light leakage, and fiber integrity. This would include the use of multiple fibers in parallel, the use of fibers serially, e.g., connecting one component to the next, as for example, with the use of an optical slip ring (“OSR”);

Optical conveyance devices—such as a beam switch, coupler, connector, OSR, temperature of these device, cooling and heat management systems for these devices, light leakage from these devices, OSR cooling system, other cooling systems, OSR alignment, beam switch alignment, other optical component alignment, other optical devices where alignment may be an issue, and a spool (or other device to handle the optical cable or conveyance device). This would include the use of multiple such devices both in serial and in parallel. It would also include the monitoring of other support or operating materials needed for the operation of such conveyance devices;

Advancement devices—this would include the mechanical components that are used for raising and lower, extending and retracting, moving, and combinations thereof, the optical cable and a high power laser tool that is at the end of the cable, such as for example a spool and injector on a coil tubing unit, or a spool on a wire line unit. This would further include, by way of example, in drilling having the capability to determine WOB and control WOB, having the ability to regulate WOB and having the ability to determine MD;

High power laser tools—this would include all of the supporting material needed for a high power laser tool, such as for example fluid flow, e.g., a liquid, compressed air, or N₂, as the motive fluid for a mud motor, fluid flow to keep the high power laser beam path clean of debris, e.g., a transmissive liquid or fluid, substantially transmissive liquid or fluid, compressed air, N₂, electric power, RPM (revolutions per minute), TVD, MD, lubrication of tools, temperature of tools and related equipment, and other conditions, or information about the operations of the tool. Further, if the tool has monitoring, measuring or analyzing functions such as MWD, LWD the operation of those functions may be monitored and controlled; and,

Interlocks—such as for example the monitoring, sensing for conditions that are out of set operating parameter, or predictive of conditions becoming out of set operating parameters, and similar types of monitoring and control that will automatically stop or shut down the laser or the unit to prevent a dangerous situation or stop the occurrence of a dangerous situation either for personnel, equipment or both.

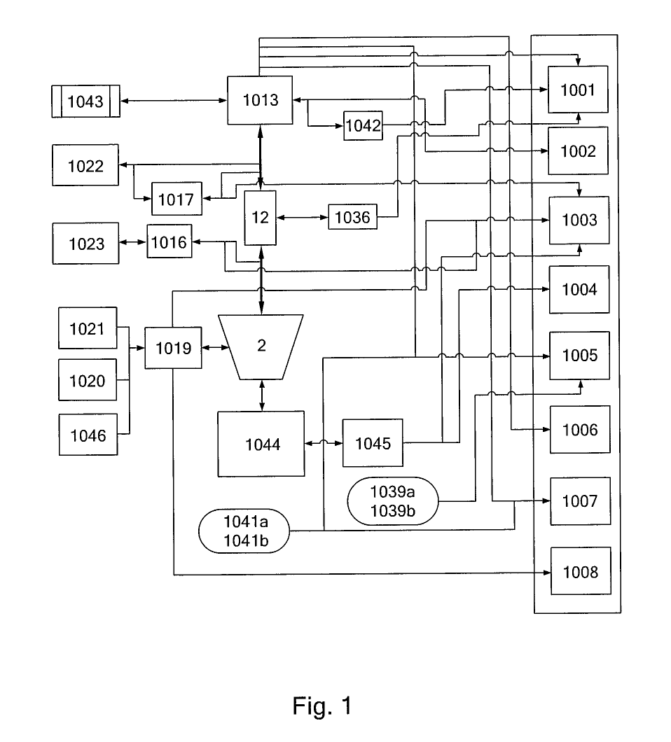

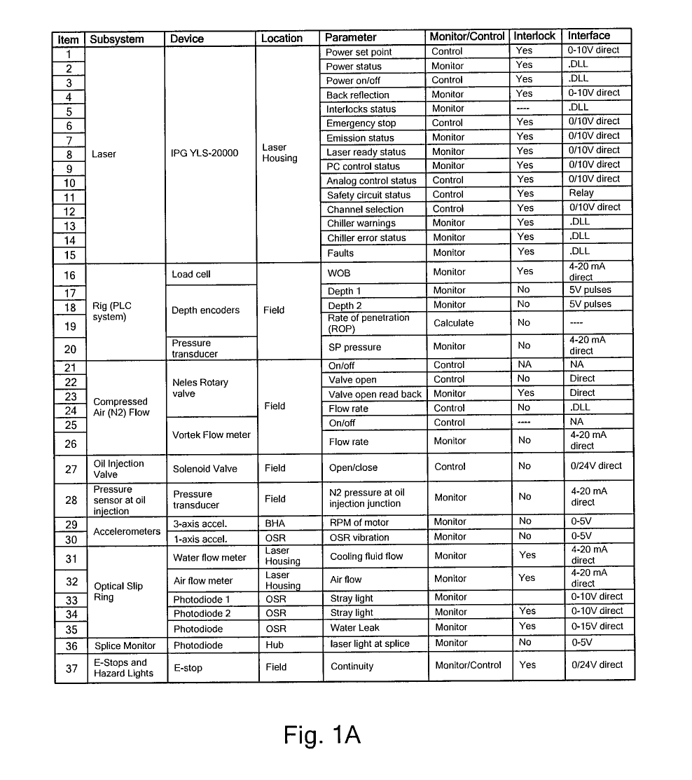

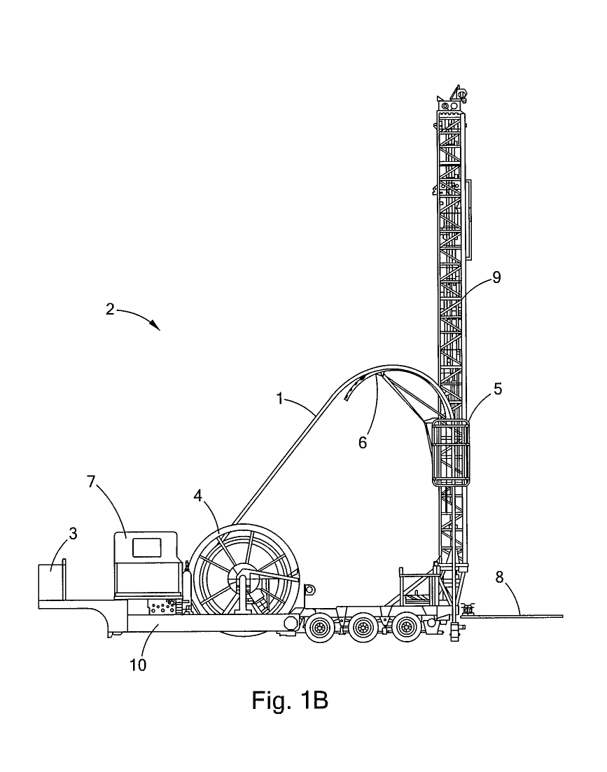

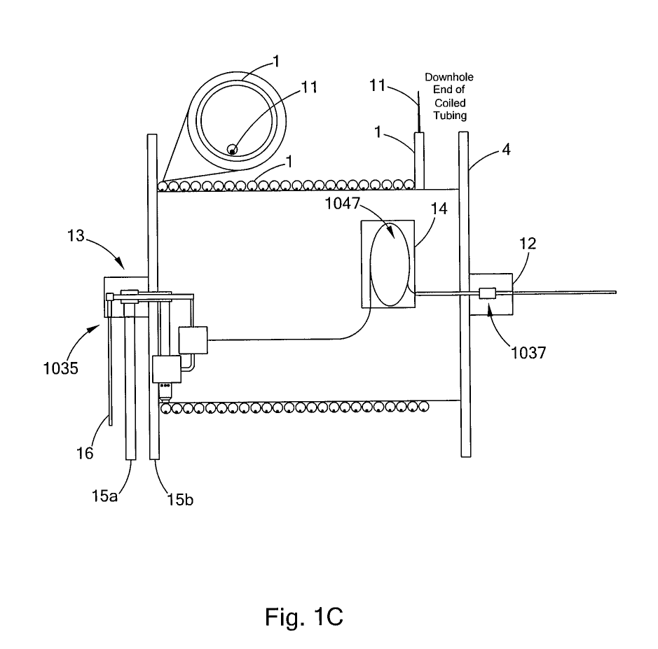

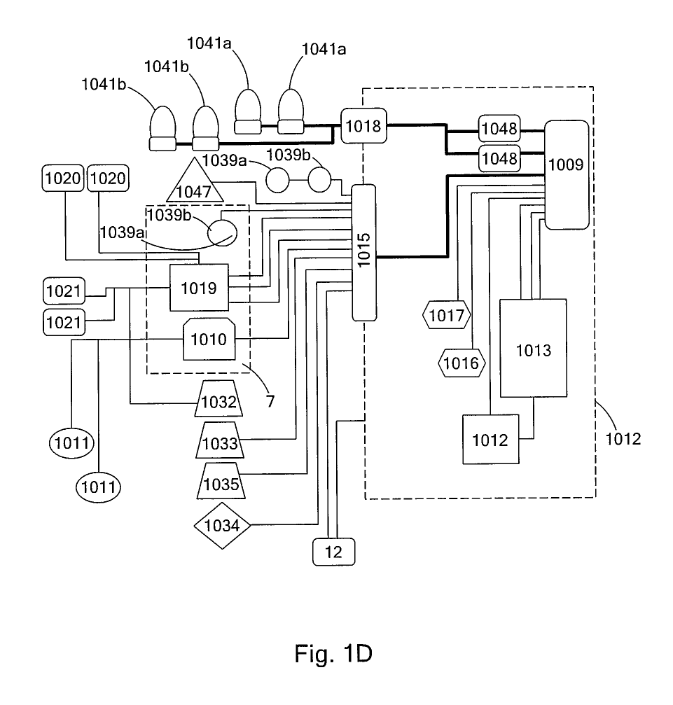

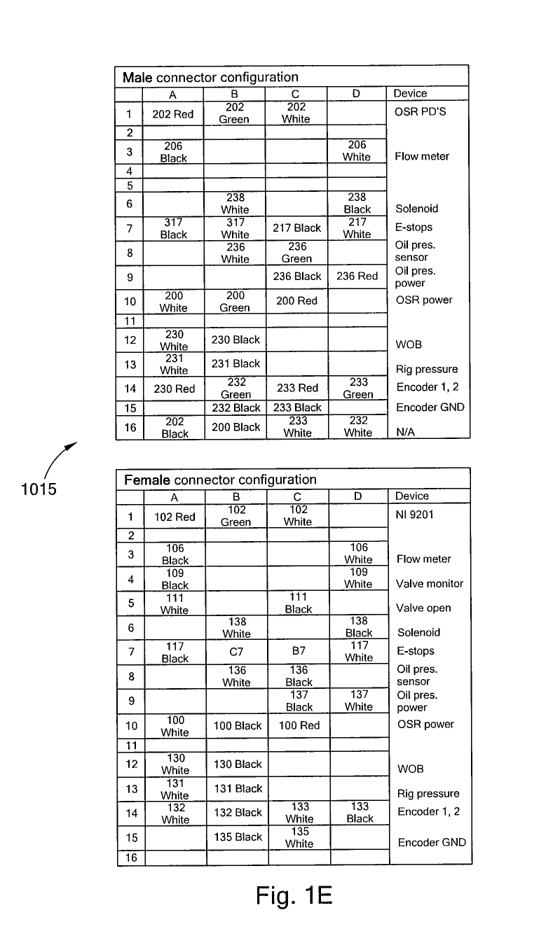

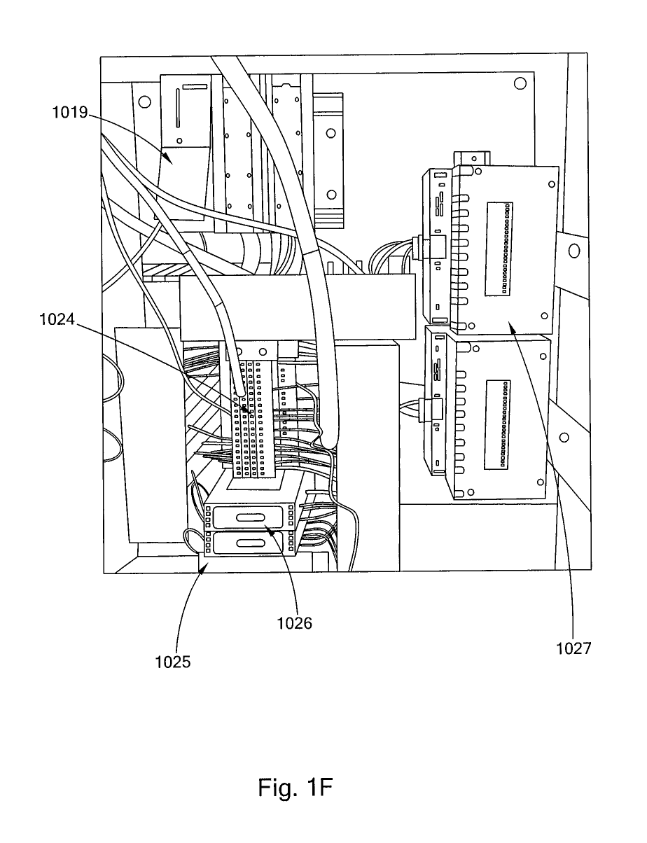

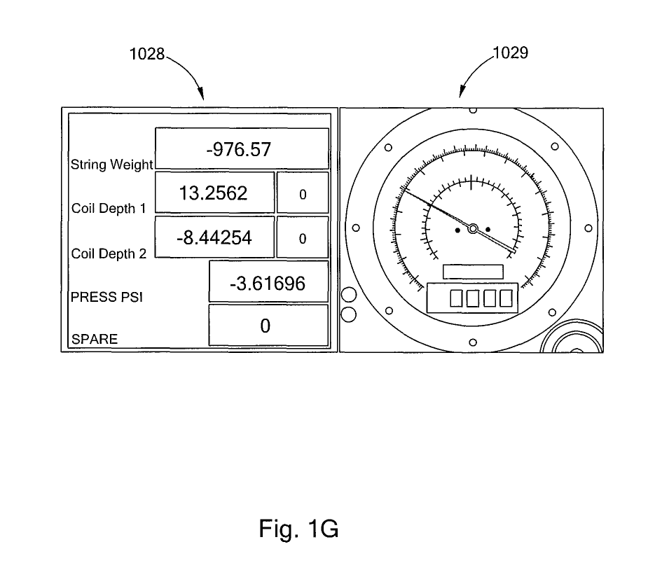

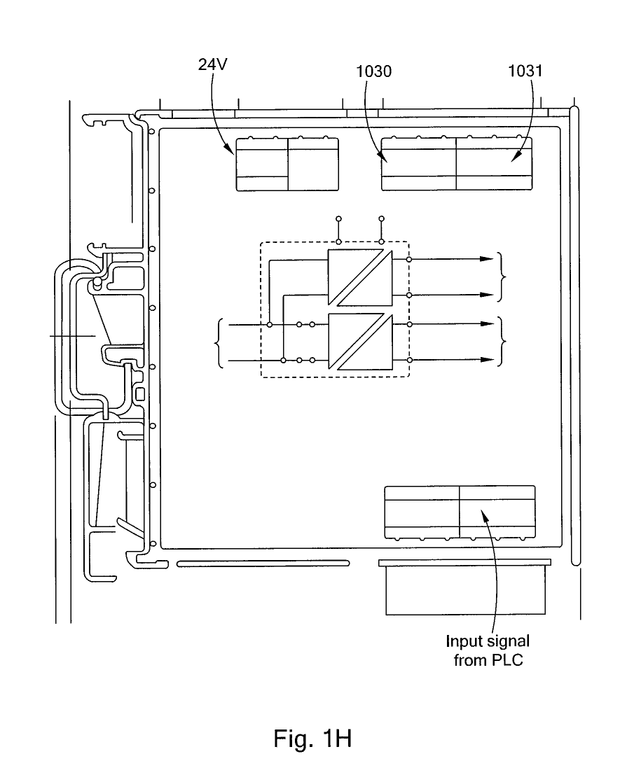

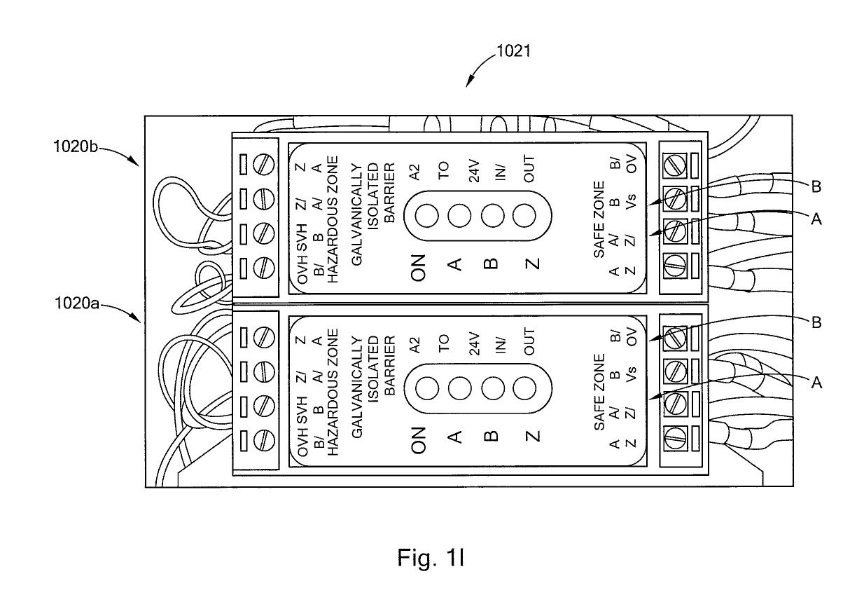

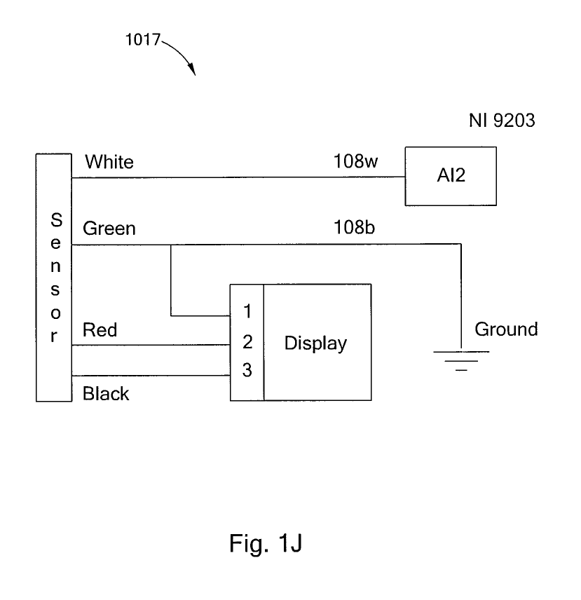

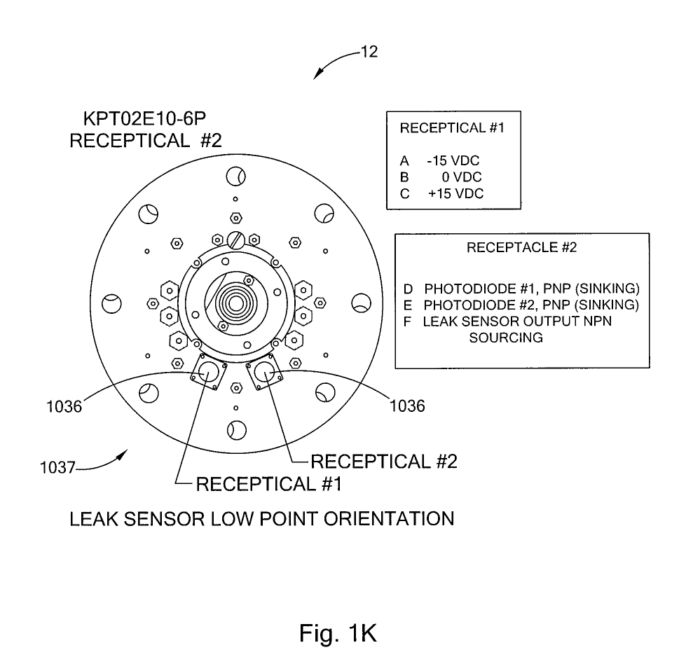

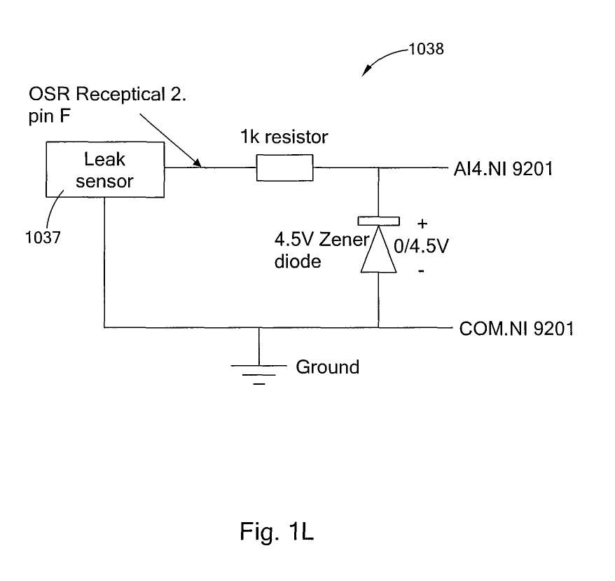

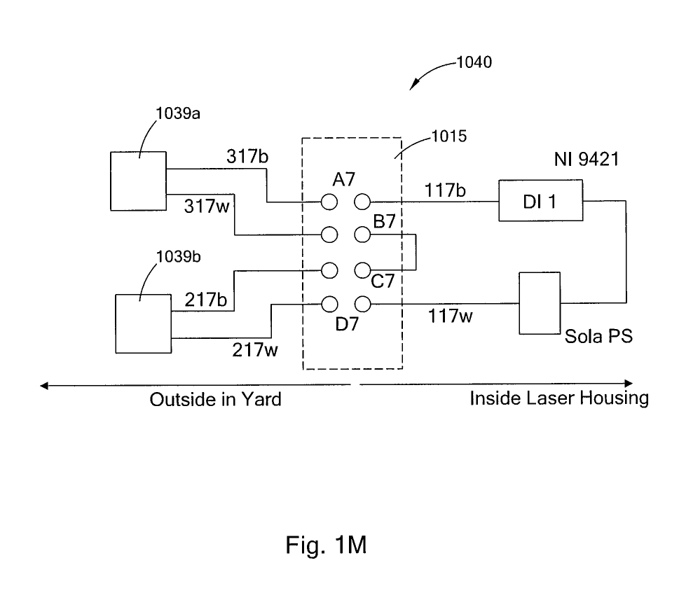

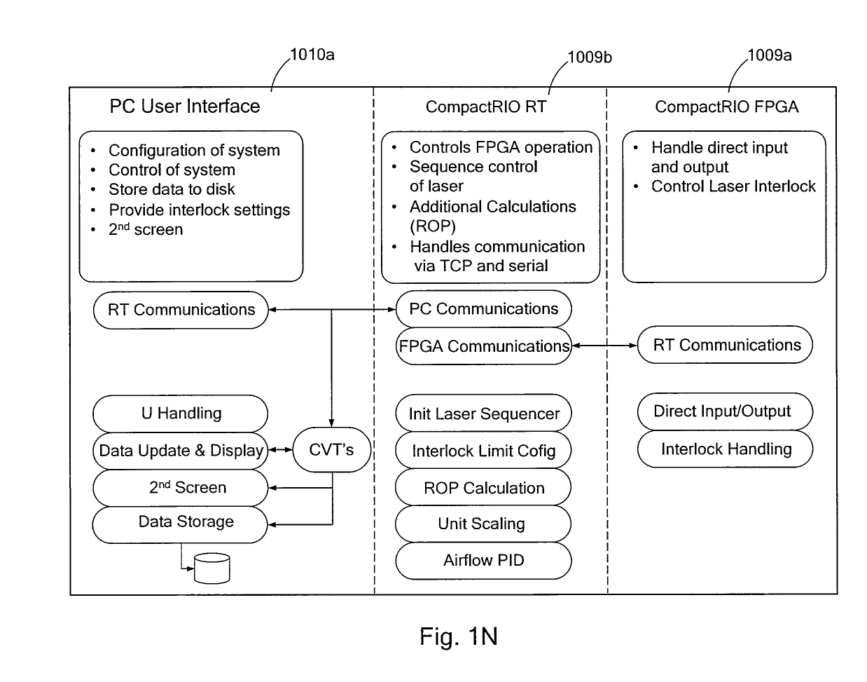

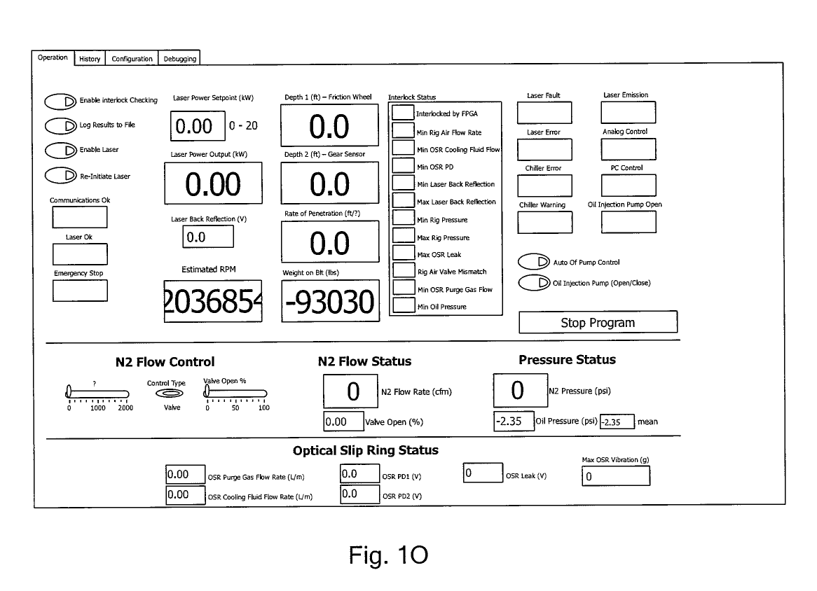

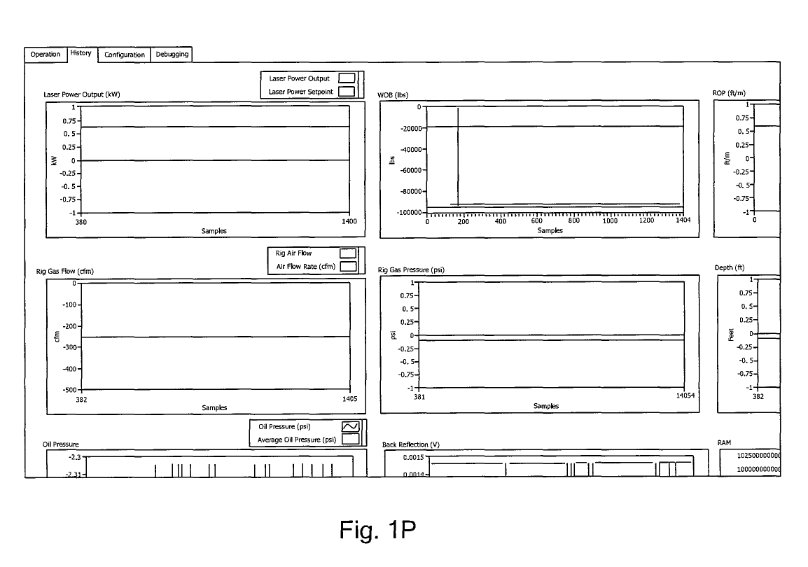

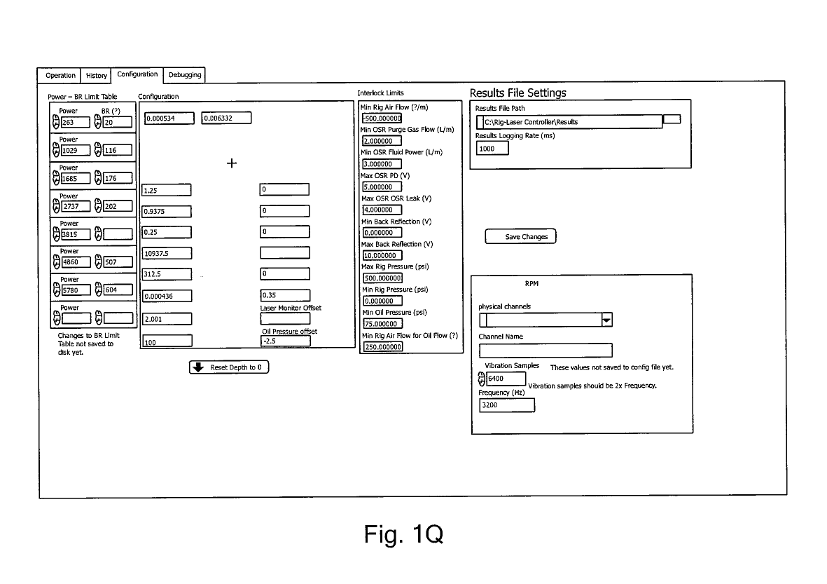

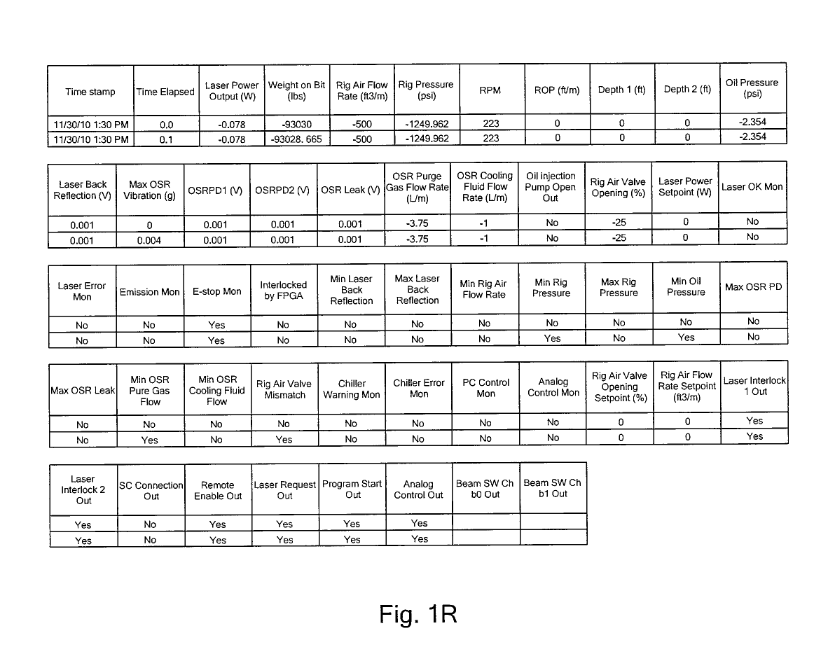

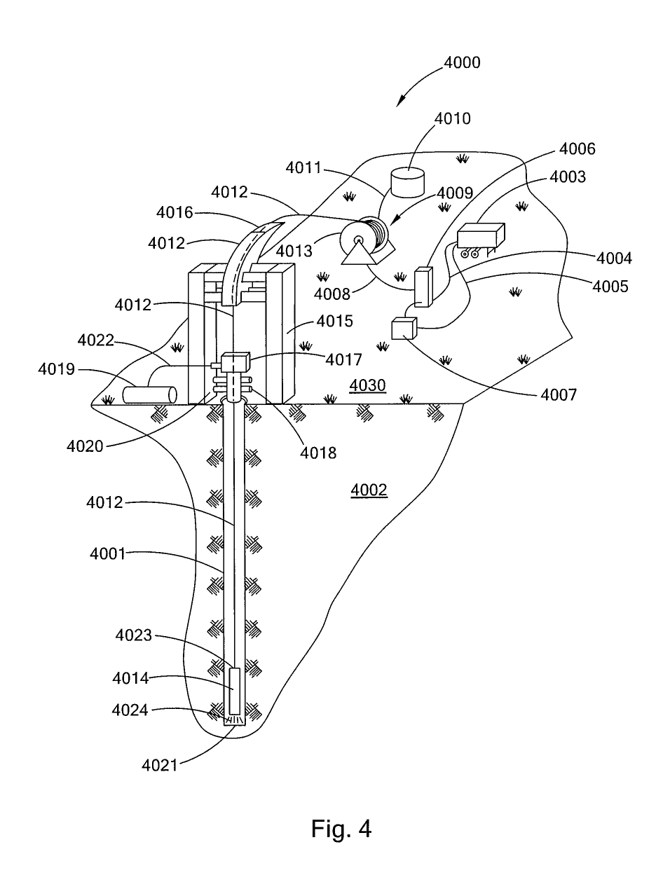

Thus, an example of an embodiment of a control and monitoring system for a high power laser unit is illustrated in FIGS. 1 and 1A to 1P, which system could be deployed with a drilling system such as illustrated in FIG. 4.

In general, FIG. 1 shows the top-level system configuration for this embodiment. FIG. 1A provides a table setting forth the interfaces in this system. FIG. 1N provides the overall software implementation and includes the principal systems and their functions for this embodiment.

In general, this embodiment of a control and monitoring system includes a LabVIEW CompactRIO (“cRIO”) embedded system to perform all critical functions with a PC (personal computer, i.e., a small unit having a processor, memory and an operating system, such as are available from IBM, Dell, and Apple) to provide user interface and data logging capabilities. Although a labVIEW system is used, other systems of factory and equipment automation and control may also be employed, such as those available from Schneider Electric, Rockwell, Siemens and Opto 22. Preferably, as with the present embodiment, an emphasis should be placed on monitoring of various parameters. The system includes for example monitoring the laser back reflection and flow rates of cooling systems. In addition, the cRIO is interfaced with various instruments to provide monitoring, logging and in some cases control of the instrument to achieve proper operation for drilling or other high power laser activities.

The CompactRIO contains both an FPGA (Field-Programable Gate Array) and a real-time processor. The FPGA handles all input from the sensors and outputs to the laser. If any of the measured values is out of the allowable range, the FPGA drops the power set point to 0 W and engages the laser interlock mechanism. The CompactRIO real-time (RT) processor handles all communication between the FPGA and PC, as well as for example, features such as features that cannot be performed on the FPGA directly. The RT software initializes the FPGA on start-up and responds to all commands from the PC. For example, when the laser power set point is changed on the PC, this command is sent to the RT software, which communicates the command to the FPGA. In addition to handling commands from the PC, it also communicates the current status to the PC. Finally, the RT software handles the rate of penetration (ROP) calculations and the control loop to control the air flow rate.

The PC software serves primarily as a user interface to allow an operator to control the system. All relevant set points, limits and controls are accessible by the user via the PC software. Other than sending the set points to the CompactRIO when they are changed, the PC has no interaction with safety mechanisms. The PC software shows the current status of all monitored parameters, and stores this data to a user specified data file.

The LabVIEW interfaces with the following devices and in the following manner, as shown in the table of FIG. 1A, and as summarized below:

Laser—
a. Control and monitor interlocks, and operation, including back reflection.
b. The laser will shut down if the amount back-reflection exceeds a factory-set value to protect the laser.
c. The system will also shut down the laser if the back reflection is reduced below a user-defined value at any output power set point.

Sensors on the Rig—
a. Load cells—monitor and record weight on bit (WOB)
b. Pressure transducer—monitor and record pressure of compressed gas to the BHA.
c. Encoders—monitor and record drilling depth and rate of penetration (ROP).

N₂ Flow Valve and Meter Assembly—
a. Control, monitor and record flow of compressed gas to the BHA. There are both manual and automatic modes. In Auto mode, the user chooses a certain flow value and the system adjusts the valve opening to provide desired flow. In the manual mode, the user can choose the valve opening from 0 to 100%.

Oil Injection Valve—
a. Control, monitor and record status of the valve that controls oil injection into the laser bottom hole assembly (“LBHA”). There are both manual and automatic modes. In Auto mode, the valve automatically opens to allow oil injection based on a user-specified N₂ flow. In the manual mode, the user can open and close the valve at any time.

Pressure Sensor at the Oil Injection—
a. Monitor and record the compressed gas (N₂) pressure at the oil injection point, to show the status of oil injection.

Accelerometers—
a. There are interfaces to two accelerometers. One is a 3-axis accelerometer and the other a 1-axis. The 3-axis accelerometer is mounted on, or in physical contact with the coiled tubing and will measure vibration of the LBHA. The RPM of the motor is determined and recorded. The 1-axis accelerometer is mounted on the OSR and will measure the vibration and record maximum vibration during operation.

Optical Slip Ring—
a. Monitor and record interlocks of photodiodes monitoring stray light in OSR.
b. Monitor and record interlocks status of leak photodiodes.
c. Monitor and record necessary fluid flows (e.g., purge gas and cooling fluid) for OSR operation.

External Emergency Stops (“E-Stops”)—
a. Activates any number of external e-stops (e.g, one, two, three, four or more) on demand to stop the laser in case of emergency.

Hazard Lights—
a. There are two types of hazard lights to warn for impending laser emission (amber color flashing lights) and also when there is actual laser emission (red flashing lights).

Turning generally to FIGS. 1, 1A, 1D, and 1N the overall system schematics, architecture, and functionality is illustrated. Like numbers in FIGS. 1, and 1A to 1N refer to like items. As shown in FIG. 1 in this embodiment there are eight National Instruments (NI) modules: 9201 Voltage Analog inputs 1001, 9263 Voltage Analog Outputs 1002, 9203 Current Analog Inputs 1003, 9265 Current Analog Outputs 1004, 9421 10V Digital Inputs 1005, 9481 Relay Digital Outputs 1006, 9472 10V Digital Outputs 1007, 9423 30V Digital Inputs 1008, to interface, control, and monitor the signals from all the instruments. A LabVIEW CompactRIO (cRIO) 1009 embedded system performs all critical functions with a PC 1010 to provide user interface and data logging capabilities. In addition an NI PS-16 24-V (10A) power supply provides power to the modules. The accelerometers 1011 interface is not through the CompactRIO (due to lack of spare channels). The interface is established through an NI Hi-Speed USB carrier, which is interfaced with the PC 1010 via USB connection.

As shown in the flow diagram of FIG. 1N the CompactRIO FPGA 1009a handles all critical aspects of the rig laser control and interlocks, and is not dependent on the other components except to receive set points and send status. The CompactRIO RT 1009b handles all communication between the FPGA and the PC user interface 1010a. It also provides sequencing to certain laser operations, including initialization and provides scaling and other processing. The PC User Interface handles all display of information to the user and sends configuration information and commands to the CompactRIO system. It also stores the received data for later analysis.

Additionally, and referring to FIG. 1N the following more detailed explanations are provided.

CompactRIO FPGA—the FPGA handles all direct input and output with the system including laser monitoring and control, pressure monitoring, valve control, etc. In addition, it handles various mechanisms including laser shutdown in the case of any monitored values being out of range. Once initialized, the FPGA is not dependent on either the RT or PC to perform its safety functions. If the PC and RT are not operational, the FPGA will still shut down the laser and engage its interlocks if any monitored parameter is out of range.

RT Communications—The RT Communications process handles all communication between the FPGA and CompactRIO RT processor. This includes receiving any set points from the RT system, handling any commands from the RT system, and transmitting the collected information to the RT system. As there is no high-speed communication required between the FPGA and RT processor, simple LabVIEW FPGA front-panel communication is used for ease of maintenance.

Direct Input/Output—The FPGA handles all direct input and output via the plug-in C-Series modules.

CompactRIO RT—The RT system handles all communication between the CompactRIO FPGA and the User Interface. It provides the necessary startup information to the FPGA as well as any changing parameters over time. It handles the rate of penetration calculation, control of the air flow and all communications with the user interface. In addition, it provides simple timing and sequencing to initialize the laser.

FPGA Communications—The FPGA Communications process handles all communication of set points, configuration and commands to the FPGA. It also reads all status and control information from the FPGA.

PC Communications—The PC Communications process handles all communication between the RT system and the PC user interface. It receives and processes any commands from the PC, and sends all status information to the PC.

PC User Interface—The PC handles all user interaction and data storage. It provides no control features, but acts as a pathway to send commands to the RT system and provide information to the operator. The PC User Interface consists of two screens, the primary user interface and the secondary display. All control is done via the primary user interface while both screens show status and history information.

RT Communications—The RT Communications process handles all communication between the PC and the RT system. It sends operator commands, set points and configuration information. It also receives all status information from the CompactRIO system.

Data Storage—The Data Storage process stores the collected data to disk at the interval configured via the PC User Interface. This data can later be viewed and analyzed as needed.

In this embodiment, the advancement device, as illustrated in FIG. 1B, is a steel coiled tubing 1, installed on a mast style coiled tubing unit 2 with power pack 3, coiled tubing reel 4, injector head 5, injector head gooseneck 6, control console 7, drilling floor 8 and mast 9, all on a single carrier 10. The loaded reel may have anywhere form a few feet, hundreds of feet up to approximately 5000 feet of coiled tubing, depending upon the intended use and the diameter of the tubing, such as for example, 80K yield strength, 2.875″ outside diameter coiled tubing with a 0.188″ wall thickness.

The coiled tubing 1 is moved by a 100K lb. pull capability, hydraulically driven injector 5 fitted with a 120″ gooseneck 6. The coiled tubing unit 2 has a single section mast 9 capable of 100K lb. capacity with an approximate height under elevated injector head of 40 feet to ground level. The unit stores the coiled tubing 1 spooled on the coiled tubing reel 5.

For operations, the coiled tubing 1 is run across the injector gooseneck 6 and into the injector head 5. The injector head has two hydraulically driven opposing chains with inserts that allow the coiled tubing pipe to pass through the center of the head.

The two chains within the injector head 5 utilized hydraulic cylinders to force the chains together, clamping down on the coiled tubing, then roll in unison to either inject the pipe downward into the well, or upward, removing pipe from the well. As the amount of force required moving the pipe in either direction is increased, so is the amount of tension of the chains/inserts on the coiled tubing pipe.

Control of the system is done from a control console 7 located to the forward side of the reel 4 on the unit trailer 10. The rig system consists of a programmable logic controller (“PLC”) for data acquisition and control and may have sensor for example of two load cells on the injector, two depth encoders and one pressure transducer, located in the rig cabin. The information from these sensors and the PLC may be interfaced into the overall system, e.g., LabVIEW cRIO.

A power pack 3, providing the necessary hydraulic power to function the unit components is located at the front of the trailer. Additionally, the power pack 3 provides a 12 volt electrical source, as well as a limited amount of air pressure from an on board compressor. The unit 2 is effectively self-sufficient until the addition of blow out preventers is required. Although not addressed in the example of this embodiment, the control and monitoring of the BOP, which could be integrated into the control system.

To accommodate a fiber optics cable 11, the coiled tubing reel 4 has been fitted with two components, as illustrated in FIG. 1C, an optical slip ring 12 and a plural flow path pressure swivel 13. The optical slip ring allows the passage of the laser being transferred through the fiber from the laser source static line to the spinning component on the reel. The fiber cable enters and exits the slip ring assembly encased in a IPG photo-optics hose, and is then transferred from the hose encasement to a ⅛″ stainless steel tubing protective sheath inside the reel assembly. The stainless steel tubing is wrapped inside a containment box 14 with excess tubing/fiber, then exits the box and enters the ⅜″ stainless steel tubing to the interior of the reel assembly with a sealed junction.

The rotating pressure joint provides a stationary to rotating pressure seal for air 15a, 15b being used to transport solids and to power the downhole motor, as well as for oil 16 being pumped to lubricate the bearings on the downhole motor during drilling operations. From the pressure swivel, at the inside of the coiled tubing reel, the pressure path for the air is channeled through the inside diameter of the coiled tubing, while the oil is directed through a ⅜″ outside diameter stainless steel tubing, installed inside of the coiled tubing.

A laser housing 1012 is used to protect and contain the laser 1013 and related equipment. For example, in this embodiment the laser housing is a 20-foot transportable container houses the laser 1013, beam switch 1014, “OSR cooling system”, chiller 1020 and the cRIO 1009 hardware. The rest of the monitoring devices are outside in the field, as illustrated in FIG. 1D. The OSR cooling system has a small portable compressor 1023, a gas mass flow meter 1016 and a flow meter 1017 switch with display. The compressor provides compressed air as purge gas for the OSR and cool DI water and tap water are diverted from the chiller's main water lines. To accommodate the transportability of the laser container, the wiring connection from outside sensors to the cRIO is made through a 64-pin Harting Han connector 1015. The cooling hoses are fitted with quick-disconnect couplings and are easily detachable. The tables, provided in FIG. 1E shows the pin diagram for the 64-pin connector 1015 and corresponding wiring designations.

Further detail of the individual devices and components in this illustrative example are provided below. It being understood that other, and other similar types, of controllers, PLCs, soft PLCs, sensors, connectors, encoders, load cells, transducers, control valves, flow sensors, sensors, monitors, pressure sensors, accelerometers, photo diodes, etc., may be employed. These and additional devices may be utilized at other and additional locations within an overall high power laser unit or system.

Detailed Description of Illustrative System Components

Laser—Laser energy is provided by a 20-kW fiber laser 1013 through a multimode fiber incased in a tubing (FIMT), which passes through all other subsystems (BHA) to provide nominal 20 kW of laser energy at the rock surface. The laser is manufactured by IPG and is a Model YLS-20000. The interface to laser is through three interface connectors: (i) Analog Interface Connector, which is a 7-pin Harting Han, for all analog inputs and analog outputs; (ii) Interface Connector, which is 25-pin Harting Han 1018, associated relays 1048 and which handles such features as Emission enable, e-stops and internal interlocks; and (iii) Hardwiring Interface Connector, which is a 64-pin Harting Han 1015 and all laser request/control and programs are handled through this interface. There is also provided back reflection monitoring system 1042. The laser has an associated laserNET applications system 1043

Rig Control system—The rig 2 is controlled by a PLC 1019, in this example a Siemens 6E57314-6CG03-0AB0 programmable logic controller (PLC) system for data acquisition from two load cells 1020 on the injector 5, two depth encoders and one pressure transducer, located in the rig cabin. A drawing of a photograph of the PLC 1019 and related I/O interfaces 1024 is provided in FIG. 1F, which also showns the current duplicator 1025, the intrinsic barriers 1026 for the encoders and a 24V power supply 1027. It being recognized that with more advanced rigs and units, or with retrofitting older or less advanced rigs, more complex and networkable controls may be utilized and incorporated into or integrated with the control network and system. The rig further has compressors 1044 and a gas flow monitoring and control system 1045 associated with those compressors, as well as, pressure sensors 1046.

Rig—Load Cells—The rig 2 has load cells 1020 for monitoring WOB. It is contemplated that the signal from the load cell or similar type of sensor could be used, via a controller or control network or system, to control WOB. In this embodiment, each load cell is a 75,000-lb LP model from Honeywell. The average of the weights from the two load cells are calculated and displayed on the HMI (human machine interface) 1028 and also on the console 1029 in the control cabin 7 of the rig 2, as shown in FIG. 1G. The output signal from the PLC for interface to the control system is analog 4-20 mA (average of the 2 load cells) from pin 14 (the first analog output port). The output signal is duplicated by a DC multi-channel current duplicator (Action Industries, model Q404-4). One output signal is fed to the HMI (“Channel 1 Out”) 1030 and the other (“Channel 2 Out”) 1031 to the cRIO control system. (As seen in FIG. 1H.) The weight limits for each load cells should be set at −75,000 lbs to 75,000 lbs on the HMI screen. Moreover, because laser-mechanical drilling enables the use of substantially lower WOBs than are used in conventional mechanical drilling, preferably, the load cells or other WOB control equipment will be operable, and more accurate in these lower WOBs, typically, for laser-mechanical drilling these WOBs will be in ranges that are less than about 5,000 lbs, less than about 2,000 lbs, less than about 1,000 lbs and less than about 500 lbs.

Rig—Encoders—Encoder 1020 are used to monitory the depth (MD) of the laser bottom hole assembly and to calculate a rate of penetration (“ROP”) of the laser-mechanical bit. It is contemplated that signals from the encoders, or similar monitoring devices could be used, via a controller, control network or system, to control MD and ROP. Two encoders 1020 are used in this embodiment. A “Gear Sensor” 1020a that is positioned on top of the injector is a 16-cycle per turn encoder BEI Sensors; model H25D-SS-16-AB-C-S-M16-EX-S. The second encoder 1020b in this embodiment is a “Friction Wheel” located at the bottom of the injector and has a higher resolution with 500 cycles per turn, which is also from BEI Sensors, model H20-EB-37-F28-SS-500-AB-S-M16. The 24V pulse trains (signals) are isolated from the hazardous area by BEI Intrinsic Barriers (model 924-60004-003) shown In FIG. 11. The pulse trains A and B are 90 degrees out of phase and are routed to both the PLC and the control system for depth and ROP calculations. The HMI displays two depths and ROP readings from each encoder. The encoders are calibrated and for the current systems the K-factors are 465.067 and 39.73 for Friction Wheel and Gear Sensor, respectively. In this system the K-factors can be changed on the HMI touch-screen panel shown in FIG. 1G.

Rig—Pressure Transducer—In this embodiment nitrogen gas is used, compressed air or a transmissive, or substantially transmissive fluid may also be employed, as the motive fluid for the positive displacement motor (“PDM”) used in the Laser Bottom Hole Assembly (“LBHA”), as well as, to keep the beam path clear and remove cuttings from the borehole. Nitrogen pressure to the coil tubing and thus the top of the LBHA, is monitored by a 5,000-psi pressure transducer 1032, which is manufactured by Stellar Technology Incorporated, Model GT2250-5000G-114. It is contemplated that single from the encoders or similar monitoring devices could be used, via a controller, control network or system (also integrated potentially into the nitrogen source control system), to control nitrogen pressure and also nitrogen flow rate 1033. Two encoders are used in this embodiment. This pressures transducer has a 24V DC excitation with 4-20 mA signal output for 0-5,000 psi. It measures the compressed gas pressure at input to the LBHA. Output signal from the PLC is an analog 4-20 mA (for 0 to 5,000 lbs).

Compressed gas valve/flow meter assembly—To monitor and control the flow of the motive fluid, in this embodiment nitrogen gas, a Nelles Rotaryglobe control valve (model ZXD02DATE060) with Quadra-power spring-diaphragm rotary actuator (model QPX2/K20) and Metso ND9000 Intelligent valve controller (model ND9103HNT-CE07) are used. This require a 4-20 mA analog signal from the controller to fully open the valve, which provides 4-20 mA signal indicating the vale position. There is also used a flow meter, which is a VorTek multiparameter Vortex shedding, model M22-VTP-16C600-L-DD-DCL-1AHL-ST-PS. This flow meter provides a 4-20 mA analog signal to indicate 0-2,000 cfm flow.

Oil Injection Valve—To lubricate the PDM in the LBHA a Model SV6001 from Omega with a DC coil Model SV12COIL-24DC pump is used. The oil from the pump is a metering type pump that injects the oil into a line that carries the oil into the LBHA, below the point where clean (for contact with optics) and oily (for providing motive force to the rotor-stator cavity) air paths are separated. The pump requires 24V DC to operate. The valve 1034 controls the flow of compressed air to the oil pump and thus provides only on-off control. Although, it is contemplated that, a metering pump that is monitored and controlled via a controller, control network or system, could be employed to monitor and control the oil flow.

Pressure transducer—To monitor that oil flow is taking place, at the oil injection section of the spool a sensor used. In this embodiment a 500-psi pressure transducer (model PX309-500G5V) 1035 is inserted in the line between the oil tank and the rotary union, on the spool. See FIG. 1C. (rotating pressure joints, and oil feed line) Thus, the flow of oil is observable, by way of pressure spikes upon pump cycles, at this point, as well as, any effect that the nitrogen pressure, or changes in nitrogen pressure, may have on oil pressure. This transducer requires a 24 V excitation voltage provided by the cRIO power supply and the output is 0-5 V for 0-500 psi pressure.

Accelerometers—Accelerometers 1011 are used as an indirect way to measure RPM of the motor, bit and LBHA. And, could also be used to measure other down hole and/or remote activities of a tools that have a predetermined vibration and/or movement pattern. This method eliminates the desirability, but not necessity of having a tachometer, or other device downhole to measure, and control based upon that measurement, motor RPM and thus bit RPM for the LBHA. It has been discovered that the RPMs of the motor can be determined based upon accelerometer data. Thus, an accelerometer(s) are placed on the coil tubing, a wire line, or other structure in mechanical-physical contact with the motor in the LBHA. The signal from the accelerometer is sampled at a particular rate, e.g., about 1,000 Hz, about 2,000 Hz, about 3,000 Hz and greater or lesser sample rates depending upon the particular configurations and anticipated RPMs. The accelerometer signal data is then processed to provide a power spectrum of a particular time interval. A power spectrum may be obtained by an FFT (Fast Fourier Transform). A four second interval, for a PDM rotating in the range of about 100-400 RPM is preferred, although longer or shorter intervals may be used this and other type motors and operating conditions. The power spectrum interval is associated with frequency windows, which windows are known to correspond to a particular RPM for a given motor, bit, or LBHA. Within the frequency window the frequency at the maximum value of the power spectrum for that window is then selected. This frequency is then provided in an HMI as the corresponding RPM. The correspondence of the power spectrum to RPM can be done by calculation based upon a known or determinable number of movements that measurable by a particular accelerometer, accelerations that will take place in a single revolution. For example knowing that a PDM has 8 nutations in a single revolution, this value could be used to calculate the correspondence of a frequency, to an RPM. Alternatively, the actual RPMs could be measured and the corresponding frequency observed, over various RPMs and thus a correspondence determined by observation.

In this embodiment there are two accelerometers that are located on the bottom of the injector 5, specifically on a device that is in direct contact with the coil tube as it exits the bottom of the injector. They are interfaced with the PC through an NI Hi-Speed USB carrier, due to lack of spare channels on the cRIO. This signal could be integrated into a controller, control system or network and which could then be used to control RPM. The signals from the accelerometers are plugged into the cabin PC via a high-speed USB connection. A 3-axis accelerometer by IMI-Sensors, part#629A31 are used in this embodiment. This will be mounted on or in physical-mechanical connection with the coil tubing to measure vibration on LBHA and the program calculates the power spectrum of the signals in 3 axes and determines the RPM of the LBHA. A 1-axis accelerometer by IMI-Sensors, part#622B01 will also be used in the embodiment. This unit will be mounted on the OSR to determine maximum g force experienced by the unit. The sample rates for the 3 axis accelerometer in this embodiment will be 3,200 Hz.

Optical Slip Ring—The optical slip ring (OSR) 12 allows the transmission of laser light from a stationary fiber optic cable to a rotating fiber optic cable. The OSR requires tap water and DI water from the laser chiller. It also requires purge gas flow 1016 for additional cooling. There are a water flow meter 1017 and an air flow meter which will monitor the flows to the OSR and are interlocked to provide warning in case of flow disruption.

OSR—Water Flow Meter—The OSR water flow meter consists of a sensor (part# PF2W504-NO3-2) and a display (part# PF2W301-A) manufactured by SMC corporation. The output is 4-20 mA for 0 to 4 L/min. A wiring configuration between this sensor, display and cRIO module NI9203 is shown in FIG. 1J.

OSR—Purge Gas Flow Meter—A loop-powered 0-15 sL/min gas mass flow meter (part# R-32468-19) from Cole-Parmer, is used to monitor the flow of purge gas to the OSR.

OSR Photodiodes and Leak Sensor—As integral parts of the OSR 12 design, there are two photodiodes 1036 and a “leak sensor” 1037 to monitor the stray light and any possible water leakage, respectively, inside the unit. The presence of stray light can signify that the components of the OSR have come out of alignment, or that other problems, or potential problems exist, or are beginning to develop with the optical system. FIG. 1K shows the side view of the OSR 12 where the detectors leads are located. A stand-alone power supply (located next to the cRIO) provides 15V and −15V to the sensors according the diagram. The location of the OSR photodiodes is shown in FIG. 1K. There are two photodiodes 1036 which monitor the intensity of the stray light inside the housing. The output range is 0-10V. A maximum intensity limit is established above which the control software warns the operator about any possible misalignment causing increase in stray light inside the unit. The wire connections to the cRIO are described in further in the wiring table (FIG. 1E) through the “feed thru” connector. The OSR water leak sensor acts as a binary switch, with a “high” state indicating water at the bottom of the unit. In normal operation, there is no output voltage (0V) but in presence of water the detector produces 15V. The input voltage range of the cRIO module (NI 9201), which monitors the detector, is 0-10 volts. Therefore a voltage clamping circuit 1038 is used (as shown in FIG. 1L) to reduce the input voltage to the module to below 10V in case of the detector's “high” state. The circuit consists of a simple 4.5V-Zener diode in series with a 1-k ohm resistor to determine the maximum voltage supplied to the cRIO module with reasonable current flow. The circuit is shown in FIG. 1L. Additionally, associated with the containment box 14, is splice monitor 1047, to detected and determine if a fiber splice in the box is failing or about to fail.

Emergency Stops—In this embodiment there are also two emergency stops, one in the cabin 1039a and one next to the injector outside 1039b. They are both interlocked in series for laser shut down in case of emergency. FIG. 1M shows the wiring diagram 1040 between the two and cRIO.

Flashing Hazard Lights—There are two kinds of flashing hazard lights 1041a, 1041b installed. Both kinds are model number 5808T94 from McMaster Carr. The first type are amber flashing hazard lights. There are two amber flashing lights in series located at different locations and are activated when the laser is ready to emit but there is no emission yet. “Program Start” signal from the laser (64-pin Hardwiring Interface Connector, pin A2) is used to control a DC relay, which would close the circuit and the lights are powered by the 24-V DC power supply. The second type of light are red flashing hazard lights. There are two red hazard lights of the same model in red color, as the yellow, the red lights are in series located at different locations in the yard. They are activated when there is laser emission. “Emission Status” signal from the laser (64-pin Hardwiring Interface Connector, pin B2) is used to control a DC relay, which would close the circuit and the lights are powered by the 24-V power supply.

The system further may have the capability through an HMI and/or a GUI, to display data, display stored data, display real-time data and operating parameter, adjust real-time operating parameters, show historic trends of information such as data and/or operating conditions and other display functions that may be useful, helpful or beneficial to the operation of the unit.

Thus, for example, FIG. 1O illustrates a display showing real-time operating data and conditions of the unit and provides the ability to adjust those parameters. FIG. 1P illustrates a display showing real-time and historic operating data and conditions, e.g., as graphs having the current data and also including earlier data for a preselected moving time period. FIG. 1Q illustrates a display showing limits for back reflects at various points in the system and provides the operator the ability to set such limits. FIG. 1R provides an illustration of a data log, or summary that may be stored and displayed by the system.

The control and monitoring systems for laser units may include and be based upon PLC based control system, soft PLC or computer based control system and would include distributed control networks, control networks, and other types of control systems general known to or used by those of skill in the factory automation and equipment automation arts. These monitoring and control system may include robotic systems, motion control and drive systems, (radio frequency Identification device) RFID systems, RF systems, and machine vision systems. They may be based upon or utilize the equipment and software of Allen-Bradley (Rockwell), Siemens, GE, Modicon (Schneider Electric) and Opto 22, by way of example. Further, these systems may be internet based, or accessible, and thus provide for the automatic and remote monitoring, upgrades, software maintenance of the overall system or components of that system.

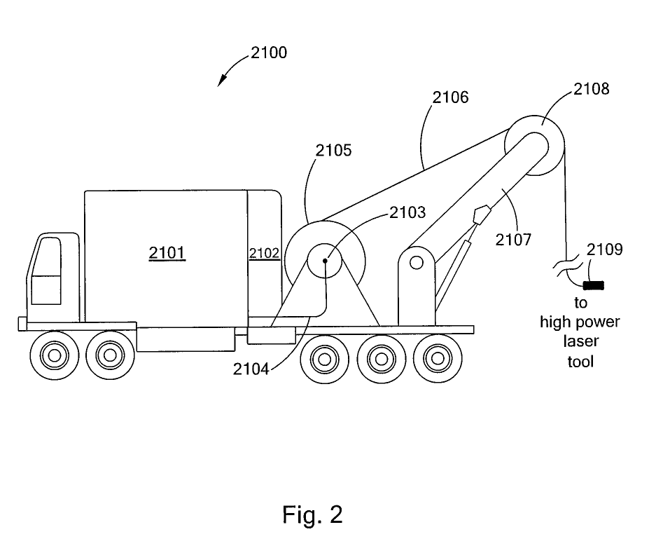

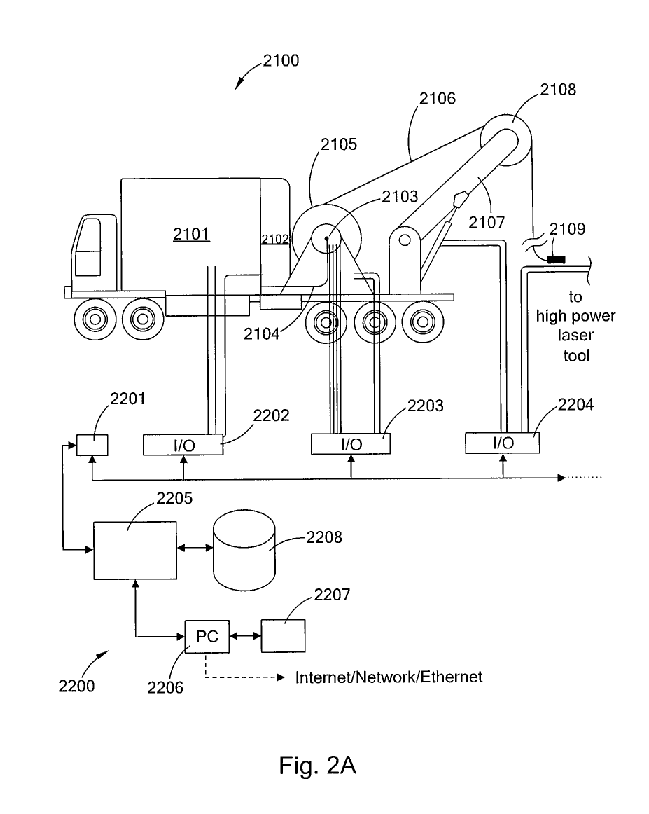

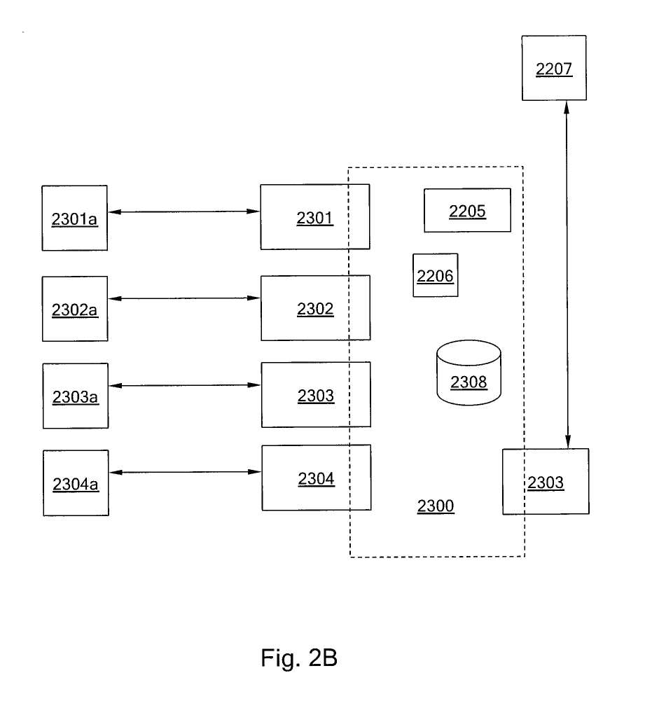

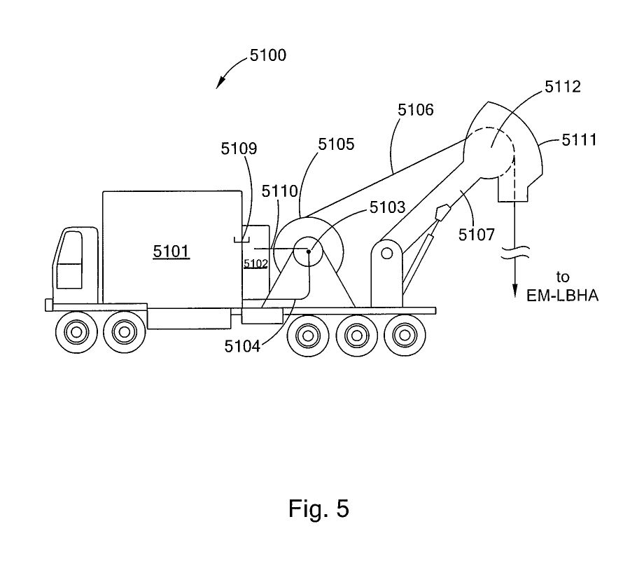

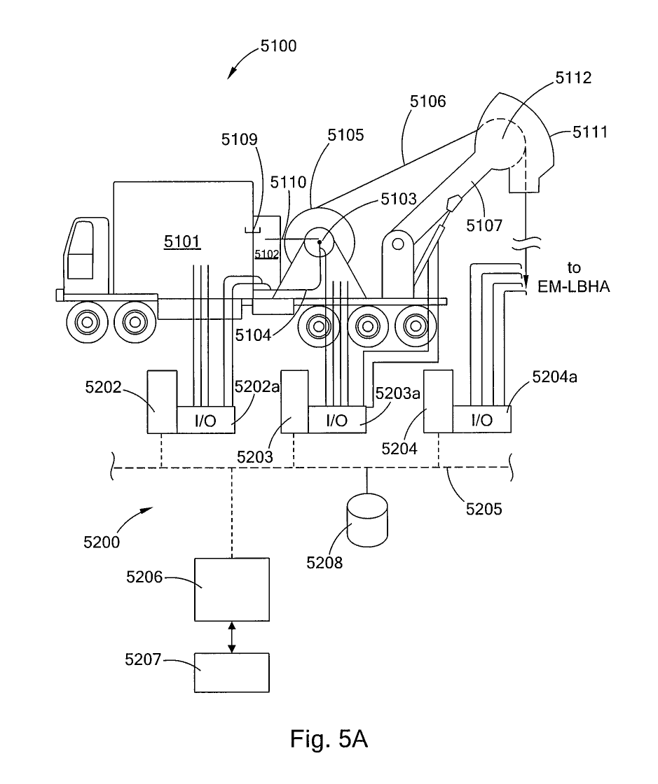

These control and monitoring systems may be used for any high power laser unit, system or tool. These control and monitoring systems my be used with, for example, the laser units shown in FIG. 2, 3, 4, 5 or 6. By way of example control systems are illustrated for the units FIGS. 2 and 5, in FIGS. 2A and 5A respectively.

In FIG. 2 there is provided an embodiment of a mobile high power laser beam delivery unit or system 2100. In the embodiment there is shown a laser room 2100. The laser room 2100 houses a 40 kW fiber laser (other laser and laser configurations may be used, such as for example 2 20 kW fiber laser), a chiller 2102, and a laser system controller, which is preferably capable of being integrated with a control system for a high power laser tool. A high power fiber 2104 leaves the laser control room 2101 and enters an optical slip ring 2103, thus optically associating the high power laser with the optical slip ring. Within the optical slip ring the laser beam is transmitted from a non-rotating optical fiber to the rotating optical fiber that is contained within the optical cable 2106 that is wrapped around spool 2105. The optical cable 2106 is associated with cable handling device 2107 that has an optical cable block 2108. The optical cable block provides a radius of curvature when the optical cable is run over it such that bending losses are minimized. When determining the size of the spool, the block or other optical cable handling devices care should be taken to avoid unnecessary bending losses to the fiber. The optical cable 2106 has a connector/coupler device 2109 that attaches (optically associates with) to the high power laser device such as a high power laser tool. The device 2109 may also mechanically connect to the tool, a separate mechanical connection device may be used, or a combination mechanical-optical connection device may be used.

The optical cable 2106 has at least one high power optical fiber, and may have additional fibers, as well as, other conduits, cables etc. for providing and receiving material, data, instructions to and from the high power laser tool. Although this system is shown as truck mounted, it is recognized the system could be mounded on, or in, other mobile or moveable platforms, such as a skid, a shipping container, a boat, a barge, a rail car, a drilling rig, a work over rig, a work boat, a vessel, a work over truck, a drill ship, or it could be permanently installed at a location.

An example of a monitoring and control system 2200 for the unit 2100 is shown in FIG. 2A. In this figure there is provided a control network 2201, which for simplicity is illustrated as having three I/O units 2202, 2203, 2204 that are networked together and connected to a controller. The controller 2205 is connoted to a PC 2206 and HMI 2207. A storage device 2208 may also be associated with the controller, as shown, or generally with network, system, or PC. Varies sensors and actuators, shown by the lines extending from the I/O are located in the unit 2100. These sensors provide signals regarding operating status and conditions of the unit, etc. and the actuators implement control functions based, in part, upon those signals and the programming of the controller. The controller may be programmed or configured by way of the PC-HMI, further real-time data, trends and stored data may be displayed on the HMI. Security codes, passwords, etc. may be implemented to restrict features, functions and access to various levels of personnel.

The flexibility of such a control network system provides the ability to control may complex functions of the unit, such as the operation of the laser tool, the operation of the laser, the operation of the OSR, as well as, having various interlocks and other procedures. The sensors may further monitor optical fiber continuity, (along various key points or the entirety of the system) back reflections (at key points or the entirety of the system), and power of laser beam being delivered from the tool, by way of example. Moreover, the system may have preset or predetermined shut down and operations sequences or parameter to address particular situations, and in particular situations that are unique to the utilization of high power laser energy. For example, if a flow a air is required at all times to maintain the optics in the down hole laser tool free from debris, than the system can be configured to always provide a minimum flow of such gas, even when an emergency shut off of the laser has occurred.

The control networks of the present inventions may be, for example, Ethernet based networks, wireless networks, dedicated or specified automation and control based networks, e.g., employing protocols, such as, MODBUS, PROFiBUS, optical fiber networks, which may include the high power optical fiber, networks of the type and configuration of the embodiment in FIGS. 1 and 1A to 1N, and combinations and variations of these and other types of automation and control networks now available or later developed.

The control system 2200 architecture is further illustrated in the schematic diagram of FIG. 2B. Module 2301 is in communication with device 2301a, such as sensors, actuators, interfaces and other devices associated with the source of high power laser energy, including for example the fiber lasers, a back reflection monitor, a cooling water flow sensor, photo diode, thermal couple, a cooling water flow actuator, interlock, interlocks, laser room temperature sensor, laser room humidity sensor, laser room door sensor, a temperature sensor, or a communication interface to the laser system controller. The communication provides for data and control information to be sent and received between the module 2301 and the devices 2301a.

Module 2302 is in communication with device 2302a, such as sensors, actuators, interfaces and other devices associated with the tubing assembly, including, for example an OSR leak detector, splice monitor, photo diode, thermal couple, sensor for spool position, optical fiber leak detector (located at the distal end, which is adjacent the tool, the proximal end which is adjacent the laser and/or along the length of the fiber), interlocks, humidity sensor, a communication interface to the handling device control system, regulator for working fluid flow, sensor for working fluid flow, back reflection detectors, spool rotation actuators, temperature sensors, or an interface to the spool control system. The communication provides for data and control information to be sent and received between the module 2302 and the devices 2302a.

Module 2303 is in communication with device 2303a, such as sensors, actuators, interfaces and other devices associated with the high power laser tool, including, for example a leak detector, a connector monitor, an interface to a MWD or LWD module or system, temperature sensor; RPM sensor, laser cutting head position indicator, cut completion monitor, spectrometer, interlocks, a communication interface to the tool control system, regulator for working fluid flow, sensor for working fluid flow, back reflection detectors, video camera, photo diode, thermal couple, or an interface to a directional drilling module or system. The communication provides for data and control information to be sent and received between the module 2303 and the devices 2303a.

Module 2304 is in communication with device 2304a, such as sensors, actuators, interfaces and other devices associated with the motive mean for the high power laser tool, for example a down hole tractor, an ROV, a laser PIG, an injector and would including, for example a load cell, a strain sensor, an interface to a tractor control system, an interface to an ROV control system, a reel actuator, a reel position sensor, an injector actuator, a means to determine depth and/or distance from the surface, interlocks, packer actuator. The communication provides for data and control information to be sent and received between the module 2304 and the devices 2304a. Further, as the tool and the motive means for the tool may be integral, as potentially in the case of a down hole tractor or laser PIG, the device 2304a may be interchangeable with, a part of, integral with, or included among with the device 2303a.

Module 2305 is in communication with a human machine interface 2207. The communication provides for data and control information to be sent and received between the module 2304 and the devices 2304a.

A control module 2300 is in communication with the modules 2301, 2302, 2303, 2304, 2305 and the controller 2203, the PC 2206, and the storage device 2208. The control module is configured to provide for data and control information to be sent and received between the control module 2300 and the modules 2301, 2302, 2303, 2304, 2305 to monitor, and control the operation of the unit 2100.

Further, the sensors, actuators, interfaces, systems and other devices and the modules of the embodiment of FIG. 2B, may also be, include and utilize the components modules and configurations of the systems in FIGS. 1, and 1A to 1R.

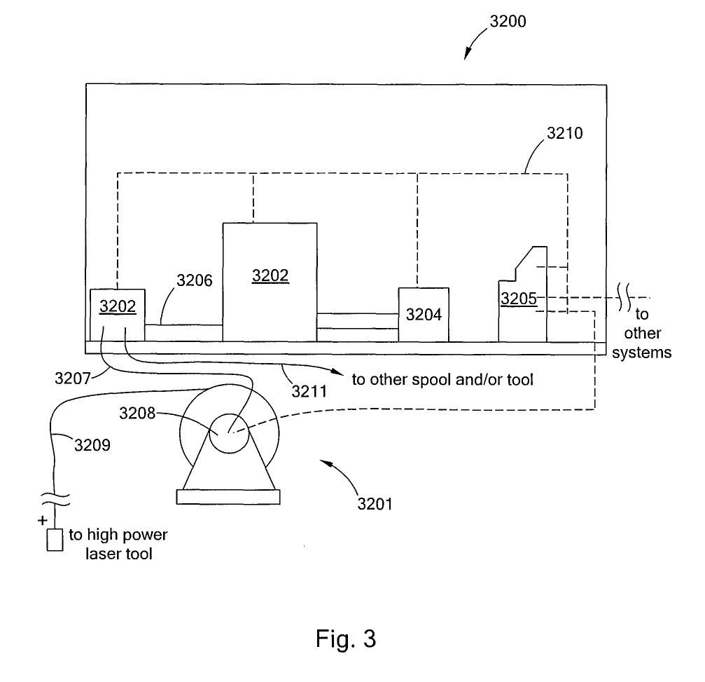

In FIG. 3 there is provided a schematic drawing of an embodiment of a laser room 3200 and spool 3201. In this embodiment the laser room 3200 contains a high power beam switch 3202, a high power laser unit 3203 (which could be a number of lasers, a single laser, or laser modules, collectively having at least about 5 kW, 10 kW, 20 kW, 30 kW 40 kW, 70 kW or more power), a chiller or connection to a chiller assembly 3204 for the laser unit 3203 and a control counsel 3205 that preferably is in control communication with a control system and network 3210. Multiple lasers may be used with a high power beam combiner to launch a about a 40 kW or greater, about a 60 kW or greater and about a 100 kW or greater laser beam down a single fiber.

Preferably, the larger comments of the chiller 3204, such as the heat exchanger components, will be located outside of the laser room 3200, both for space, noise and heat management purposes. The high power laser unit 3203 is optically connected to the beam switch 3202 by high power optical fiber 3206. The beam switch 3202 optically connects to spool 3201 by means of an optical slip ring 3208, which in turn optically and rotationally connects to the optical cable 3209. In higher power systems, e.g., greater than 20 kW the use of multiple fibers, multiple beam switches, and other multiple component type systems may be employed. The optical cable is then capable of being attached to a high power laser tool. A second optical cable 3211, which could also be just an optical fiber, leaves the beam switch 3202. This cable 3211 could be used with a different spool for use with a different tool, or directly connect to a tool. Electrical power can be supplied from the location where the laser room is located, from the mobile unit that transported the laser room, from separate generators, separate mobile generators, or other sources of electricity at the work site or bought to the work site. Other optical configurations and transmitting components, instead of, in combination with, or in addition to the optical slip rings and beam switches may be utilized.

Preferably in a high power laser system a controller is in communication, via a network, cables fiber or other type of factory, marine or industrial data and control signal communication medium with the laser tool and potentially other systems at a work site. The controller may also be in communication with a first spool of high power laser cable, a second spool of high power laser cable and a third spool of high power laser cable, etc.

In FIG. 4 there is provided an embodiment of a high power laser drilling workover and completion system as deployed in the field for conducting drilling operations, using a LBHA, that is powered by a PDM. A control system as described in detail above, as generally shown in FIGS. 2A, 5A or as otherwise taught or disclosed herein may be used with this system. The control system may be expanded, or networked with other control systems, to provide an integrated control network for some, or all of the components disclosed in that deployment. Thus, the laser drilling system 4000 is shown as deployed in the field in relation to the surface of the earth 4030 and a borehole 4001 in the earth 4002. There is also an electric power source 4003, e.g. a generator, electric cables 4004, 4005, a laser 4006, a chiller 4007, a laser beam transmission means, e.g., an optical fiber, optical cable, or conveyance device 4008, a spool or real 4009 for the conveyance device, a source of working fluid 4010, a pipe 4011 to convey the working fluid, a down hole conveyance device 4012, a rotating optical transition device 4013, a high power laser tool 4014, a support structure 4015, e.g., a derrick, mast, crane, or tower, a handler 4016 for the tool and down hole conveyance device, e.g., an injector, a diverter 4017, a BOP 4018, a system to handle waste 4019, a well head 4020, a bottom 4021 of the borehole 4001, a connector 4022.

Further control systems and networks, for individual drill sites, fields, work locations, or units may be linked together to provide realtime data and information to a centralized location. Further the centralized location may have control over ride, co-control, and/or authorization control capabilities. Thus, such a remote location may have to be pooled and approval received prior to a particular command or operation being initiated. For example, remote approval could be required before stored data is deleted or transferred; or before the laser was fired for the first time, to insure a level of approval prior to the first operation of the laser.

In addition to the injector, gravity, pressure, fluids, differential pressure, buoyancy, a movable packer arrangement, and tractors, PIGs, ROVs, crawlers and other motive means may be used to advance the laser tool to its location of operation, such as for example to advance the laser tool to a predetermined location on an off shore platform to be decommissioned, a predetermined location in a borehole, for example, the bottom of the borehole so that it may be laser-mechanically drilled to drill and advance the borehole.

In FIG. 5 there is provided an embodiment of a mobile high power laser beam delivery system 5100 for use with an EM-LBHA (electric motor laser bottom hole assembly) for advancing boreholes. In the embodiment there is shown a laser room 5100. The laser room 5100 houses a 60 kW source of laser energy, which may be one, two, three or more fiber lasers, a chiller (or chiller interface, so that the larger heat exchanger and management section of the chiller unit can be located outside of the laser room either), a source of electrical power 5102, and a laser system controller, which is preferably capable of being integrated with a control system for the EM-LBHA. One, two or several, high power fiber(s) 5104 leaves the laser room 5101 and enters an electrical slip ring/optical slip ring assembly 5103, (for the purposes of illustration both the high power optical fiber(s) 5104 and the electrical power line 5110 are shown going into the same side of the spool; it is noted that the fiber and the electrical line could connect on different or opposites sides of the spool). There is also shown an electrical line to power the lasers 5109. (It being under stood that a separate generator, no on the truck may be employed, and in some configurations may be preferable to reduce or eliminate vibration, noise, and to reduce the overall foot print or area of the laser unit 5100.) The conveyance device 5106, e.g. a composite tube having electrical lines and optical fibers built into is wall is wound around spool 5105. Within the electrical/optical slip ring the laser beam is transmitted from a non-rotating optical fiber to the rotating optical fiber that is contained within the conveyance device 5106 that is wrapped around spool 5105. Similarly, the electrical from electric power line 5110 is transferred by the electrical slip ring to the electric power lines in conveyance device 5106.

The conveyance device 5106 is associated with injector 5111 for advancing and retrieving the conveyance device, which injector is associated with a handling device 5107. Within the injector 5111 there is a path of travel 5112 that has a minim radius of curvature when the conveyance device 5106 is run through the injector 5111. This minim radius should be such as to reduce or eliminate bending losses to the laser beam energy. When determining the size of the minim radius, the spool, or other conveyance device handling devices care should be taken to avoid unnecessary bending losses to the optical fiber associated with the conveyance device.

The conveyance device should have at least one high power optical fiber, may have an electric power source for the electric motor and may have additional fibers, as well as, other conduits, cables etc. for providing and receiving material, data, instructions to and from the electric motor bottom hole assembly, optics and/or bit. Although this system is shown as truck mounted, it is recognized the system could be mounded on or in other mobile or moveable platforms, such as a skid, a shipping container, a boat, a barge, a rail car, a drilling rig, a work boat, a work over rig, a work over truck, a drill ship, or it could be permanently installed at a location.

In general, and by way of example a laser room may contain a high power beam switch, a high power laser source (which could be a number of lasers, a single laser, or laser modules, collectively having at least about 5 kW, 10 kW, 20 kW, 30 kW 40 kW, 70 kW or more power), a chiller or a connection to a chiller assembly for the laser unit and a control counsel that preferably is in control communication with a control system and network. Preferably, the larger comments of the chiller, such as the heat exchanger components, will be located outside of the laser room, both for space, noise and heat management purposes. In higher power systems, e.g., greater than 20 kW the use of multiple fibers and other multiple component type systems may be employed. The optical fiber in the conveyance device is then capable of being attached to a high power EM-LBHA, optics and/or bit. Electrical power can be supplied from the location where the laser room is located, from the mobile unit that transported the laser room, from separate generators, separate mobile generators, or other sources of electricity at the work site or bought to the work site. Separate or the same sources of electric for the laser and the EM-LBHA may be employed, depending upon, such factors as cost, availability power requirements, type of power needed etc.

In FIG. 5A there is shown an illustration of a distributed control network or system 5200 for the laser unit or system of the embodiment of FIG. 5. In FIG. 5 there is shown a series of several controllers 5202, 5203, 5204, each having its own I/O 5202a, 5203a, 5204a and associated sensor and actuators. The controllers are then configured on a control network 5235. In this manner a separate controller can be focused on specific task or specific section of the laser unit, yet still be in control communication with the other controllers. Thus, for example a control may primarily focus on the laser, laser delivery system and fiber continuity, while another may focus on the operation, monitoring and control of the electric motor. The control network 5204 is connoted to a PC 5206 and HMI 5207 and a storage device 5208. Varies sensors and actuators, shown by the lines extending from the I/O are located in the unit 5100. These sensors provide signals regarding operating status and conditions of the unit, etc. and the actuators implement control functions based, in part, upon those signals and the programming of the controller. The controllers may be programmed or configured by way of the PC-HMI, further real-time data, trends and stored data may be displayed on the HMI. Security codes, passwords, etc. may be implemented to restrict features, functions and access to various levels of personnel.

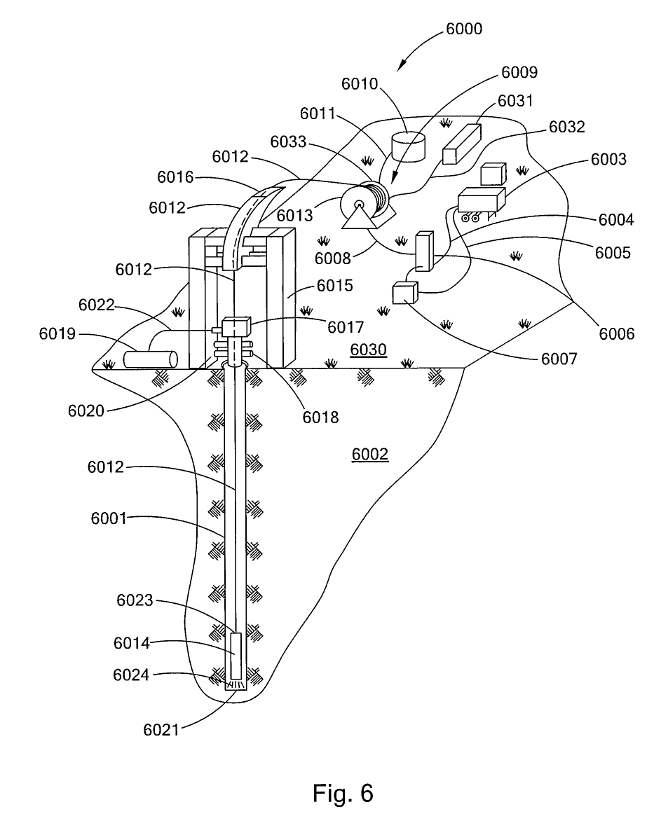

In FIG. 6 there is shown an illustrated drawing of a laser drilling, workover and completion system as deployed and utilizing an electric motor in a LBHA (EM-LBHA) for drilling activities. A control system as described in detail above, as generally shown in FIGS. 2A, 5A or as otherwise taught or disclosed herein may be used with this system. The control system may be expanded, or networked with other control system, to provide an integrated control network for some, or all of the components disclosed in that deployment. Thus, the laser drilling system 6000 is shown as deployed in the field in relation to the surface of the earth 6030 and a borehole 6001 in the earth 6002. There is also an electric power source 6003, e.g. a generator, electric cables 6004, 6005, a laser 6006, a chiller 6007, a laser beam transmission means, e.g., an optical fiber, optical cable, or conveyance device 6008, a spool or real 6009 for the conveyance device, a source of working fluid 6010, a pipe 6011 to convey the working fluid, a down hole conveyance device 6012, a rotating optical transition device 6013, an EM-LBHA 6014, a support structure 6015, e.g., a derrick, mast, crane, or tower, a handler 6016 for the tool and down hole conveyance device, e.g., an injector, a diverter 6017, a BOP 6018, a system to handle waste 6019, a well head 6020, a bottom 6021 of the borehole 6001, a connector 6022.

Further embodiments and teachings regarding high power optical fiber cable, fibers and the systems and components for delivering high power laser energy over great distances from the laser to a remote location for use by a tool are disclosed and set forth in detail in the following US Patent Applications and US Patent Application Publications: 2010/0044106, 2010/0215326, 2010/0044103, and 2012/0020631, the entire disclosures of each of which are incorporated herein by reference. These embodiments may be used in conjunction with, and thus monitored and controlled by, the control systems set forth in this specification.

One or more high power optical fibers, as well as, lower power optical fibers may be used or contained in a single cable that connects the tool to the laser system, this connecting cable could also be referred to herein as a tether, an umbilical, wire line, or a line structure. The optical fibers may be very thin on the order of hundreds of μm (microns), e.g., greater than about 100 μm. These high power optical fibers have the capability to transmit high power laser energy having many kW of power (e.g., 5 kW, 10 kW, 20 kW, 50 kW or more) over many thousands of feet. The high power optical fibers further provides the ability, in a single fiber, although multiple fibers may also be employed, to convey high power laser energy to the tool, convey control signals to the tool, and convey back from the tool control information and data (including video data). In this manner the high power optical fiber has the ability to perform, in a single very thin, less than for example 1000 μm diameter fiber, the functions of transmitting high power laser energy for activities to the tool, transmitting and receiving control information with the tool and transmitting from the tool data and other information (data could also be transmitted down the optical cable to the tool). As used herein the term “control information” is to be given its broadest meaning possible and would include all types of communication to and from the laser tool, system or equipment.

The laser systems of the present invention may utilize a single high power laser, or they may have two or three high power lasers, or more. High power solid-state lasers, specifically semiconductor lasers and fiber lasers are preferred, because of their short start up time and essentially instant-on capabilities. The high power laser beam may have 10 kW, 20 kW, 40 kW, 80 kW or more power; and have a wavelength in the 800 nm to 1600 nm range. The high power lasers for example may be fiber lasers or semiconductor lasers having 10 kW, 20 kW, 50 kW or more power and, which emit laser beams with wavelengths from about 1083 to about 2100 nm, for example about the 1550 nm (nanometer) ranges, or about 1070 nm ranges, or about the 1083 nm ranges or about the 1900 nm ranges (wavelengths in the range of 1900 nm may be provided by Thulium lasers). Examples of preferred lasers, and in particular solid-state lasers, such as fibers lasers, are disclosed and taught in the following US Patent Application Publications 2010/0044106, 2010/0044105, 2010/0044103, 2010/0215326 and 2012/0020631, the entire disclosure of each of which are incorporated herein by reference. By way of example, and based upon the forgoing patent applications, there is contemplated the use of a 10 kW laser, the use of a 20 kW, the use of a 40 kW laser, as a laser source to provide a laser beam having a power of from about 5 kW to about 40 kW, greater than about 8 kW, greater than about 18 kW, and greater than about 38 kW at the work location, or location where the laser processing or laser activities, are to take place. There is also contemplated, for example, the use of more than one, and for example, 4, 5, or 6, 20 kW lasers as a laser source to provide a laser beam having greater than about 40 kW, greater than about 60 kW, greater than about 70 kW, greater than about 80 kW, greater than about 90 kW and greater than about 100 kW. One laser may also be envisioned to provide these higher laser powers.

High powered optical cables, spools of cables, creels, and reels of cables of the type disclosed and taught in the following US Patent Applications and US Patent Application Publications: 2010/0044104, 2010/0044103, 2010/0215326, 2012/0020631, Ser. No. 13/366,882, and Ser. No. 13/210,581, the entire disclosures of each of which are incorporated herein by reference, may be preferably used as high power laser cables, structures and conveyance and deployment devices. Thus, the laser cable may be: a single high power optical fiber; it may be a single high power optical fiber that has shielding; it may be a single high power optical fiber that has multiple layers of shielding; it may have two, three or more high power optical fibers that are surrounded by a single protective layer, and each fiber may additionally have its own protective layer; it may contain other conduits such as a conduit to carry materials to assist a laser cutter, for example oxygen; it may have other optical or metal fiber for the transmission of data and control information and signals; it may be any of the combinations set forth in the forgoing patents and combinations thereof.

In general, the optical cable, e.g., structure for transmitting high power laser energy from the system to a location where high power laser activity is to be performed by a high power laser device or tool, may, and preferably in some applications does, also serve as a conveyance device for the high power laser device or tool. The optical cable, e.g., conveyance device can range from a single optical fiber to a complex arrangement of fibers, support cables, shielding on other structures, depending upon such factors as the environmental conditions of use, tool requirements, tool function(s), power requirements, information and data gathering and transmitting requirements, etc.

Generally, the optical capable may be any type of line structure that has a high power optical fiber associated with it. As used herein the term line structure should be given its broadest construction, unless specifically stated otherwise, and would include without limitation, wireline, coiled tubing, logging cable, cable structures used for completion, workover, drilling, seismic, sensing logging and subsea completion and other subsea activities, scale removal, wax removal, pipe cleaning, casing cleaning, cleaning of other tubulars, cables used for ROV control power and data transmission, lines structures made from steel, wire and composite materials such as carbon fiber, wire and mesh, line structures used for monitoring and evaluating pipeline and boreholes, and would include without limitation such structures as Power & Data Composite Coiled Tubing (PDT-COIL) and structures such as Smart Pipe®. The optical fiber configurations can be used in conjunction with, in association with, or as part of a line structure.

These optical cables may be very light. For example an optical fiber with a Teflon shield may weigh about ⅔ lb per 1000 ft, an optical fiber in a metal tube may weight about 2 lbs per 1000 ft, and other similar, yet more robust configurations may way as little as about 5 lbs or less, about 10 lbs or less, and about 100 lbs or less. Should weight not be a factor and for very harsh and/or demanding uses the optical cables could weight substantially more.

The tools that are useful with high power laser systems, and which can be controlled and monitored by the control systems described herein, many generally be laser cutters, laser cleaners, laser monitors, laser welders and laser delivery assemblies that may have been adapted for a special use or uses. Configurations of optical elements for culminating and focusing the laser beam can be employed with these tools to provide the desired beam properties for a particular application or tool configuration. A further consideration, however, is the management of the optical effects of fluids or debris that may be located within the beam path between laser tool and the work surface.

It is advantageous to minimize the detrimental effects of such fluids and materials and to substantially ensure, or ensure, that such fluids do not interfere with the transmission of the laser beam, or that sufficient laser power is used to overcome any losses that may occur from transmitting the laser beam through such fluids. To this end, mechanical, pressure and jet type systems may be utilized to reduce, minimize or substantially eliminate the effect of these fluids on the laser beam. The control systems can monitor and control some, primary, preferably significant, and most preferably all major operations, parameters or conditions of such high power laser equipment, processes and activities.

For example, mechanical devices may be used to isolate the area where the laser operation is to be performed and the fluid removed from this area of isolation, by way of example, through the insertion of an inert gas, or an optically transmissive fluid, such as an oil, kerosene, or diesel fuel. The use of a fluid in this configuration has the added advantage that it is essentially incompressible. Preferably, if an optically transmissive fluid is employed the fluid will be flowing. In this manner the overheating of the fluid, from the laser energy passing through it, may be avoided use of an optically fluid will be flowing. Moreover, a mechanical snorkel like device, or tube, which is filled with an optically transmissive fluid (gas or liquid) may be extended between or otherwise placed in the area between the laser tool and the work surface or area. A jet of high-pressure gas may be used with the laser beam. The high-pressure gas jet may be used to clear a path, or partial path for the laser beam. The gas may be inert, or it may be air, oxygen, or other type of gas that accelerates the laser cutting. The use of oxygen, air, or the use of very high power laser beams, e.g., greater than about 1 kW, could create and maintain a plasma bubble, a vapor bubble, or a gas bubble in the laser illumination area, which could partially or completely displace the fluid in the path of the laser beam. If such a bubble is utilized, preferably the size of the bubble should be maintained as small as possible, which will avoid, or minimize the loss of power density. The control systems can monitor and control some, primary, preferably significant, and most preferably all major operations, parameters or conditions of such high power laser equipment, processes and activities.

A high-pressure laser liquid jet, having a single liquid stream, may be used with the laser beam. The liquid used for the jet should be transmissive, or at least substantially transmissive, to the laser beam. In this type of jet laser beam combination the laser beam may be coaxial with the jet. This configuration, however, has the disadvantage and problem that the fluid jet does not act as a wave-guide. A further disadvantage and problem with this single jet configuration is that the jet must provide both the force to keep the drilling fluid away from the laser beam and be the medium for transmitting the beam. The control systems can monitor and control some, primary, preferably significant, and most preferably all major operations, parameters or conditions of such high power laser equipment, processes and activities.

A compound fluid laser jet may be used as a laser tool. The compound fluid jet has an inner core jet that is surrounded by annular outer jets. The laser beam is directed by optics into the core jet and transmitted by the core jet, which functions as a waveguide. A single annular jet can surround the core, or a plurality of nested annular jets can be employed. As such, the compound fluid jet has a core jet. This core jet is surrounded by a first annular jet. This first annular jet can also be surrounded by a second annular jet; and the second annular jet can be surrounded by a third annular jet, which can be surrounded by additional annular jets. The outer annular jets function to protect the inner core jet from the drill fluid present in the annulus between the laser cutter and the structure to be cut. The core jet and the first annular jet should be made from fluids that have different indices of refraction. Further details, descriptions, and examples of such compound fluid laser jets and laser cutting assemblies, systems and methods are disclosed and taught in U.S. patent application Ser. No. 13/222,931, the entire disclosure of which is incorporated herein by reference. The systems of the present inventions can monitor and control, for example, some, primary, preferably significant, and most preferably all major operations, parameters or conditions of such high power laser equipment, processes and activities.

The angle at which the laser beam contacts a surface of a work piece may be determined by the optics within the laser tool or it may be determined the positioning of the laser cutter or tool. The laser tools have a discharge end from which the laser beam is propagated. The laser tools also have a beam path. The beam path is defined by the path that the laser beam is intended to take, and extends from the discharge end of the laser tool to the material or area to be illuminated by the laser. The systems of the present inventions can, for example monitor and adjust beam properties, tool position and other operating criteria to adjust for, or that affect, the conditions of the beam path.

The conveyance device for the laser tools transmits or conveys the laser energy and other materials that are needed to perform the operations. Although shown as a single cable multiple cables could be used. Thus, for example, in the case of a laser tool employing a compound fluid laser jet the conveyance device could include a high power optical fiber, a first line for the core jet fluid and a second line for the annular jet fluid. These lines could be combined into a single cable or they may be kept separate. Additionally, for example, if a laser cutter employing an oxygen jet is utilized, the cutter would need a high power optical fiber and an oxygen line. These lines could be combined into a single tether or they may be kept separate as multiple tethers. The lines and optical fibers should be covered in flexible protective coverings or outer sheaths to protect them from fluids, the work environment, and the movement of the laser tool to a specific work location, for example through a pipeline or down an oil, gas or geothermal well, while at the same time remaining flexible enough to accommodate turns, bends, or other structures and configurations that may be encountered during such travel. The systems of the present inventions can monitor and control some, primary, preferably significant, and most preferably all major operations, parameters or conditions of such high power laser equipment, processes and activities.

The systems and methods of the present inventions are, in part, directed to the cleaning, resurfacing, removal, and clearing away of unwanted materials, e.g., build-ups, deposits, corrosion, or substances, in, on, or around structures, e.g. the work piece, or work surface area. Such unwanted materials would include by way of example rust, corrosion, corrosion by products, degraded or old paint, degraded or old coatings, paint, coatings, waxes, hydrates, microbes, residual materials, biofilms, tars, sludges, and slimes. The present inventions enable the ability to have laser energy of sufficient power and characteristics to be transported over great lengths and delivered to remote and difficult to access locations. Although an application for the present inventions would be in field of “flow assurance,” (a broad term that has been recently used in the oil and natural gas industries to cover the assurance that hydrocarbons can be brought out of the earth and delivered to a customer, or end user) they would also find many applications and uses in other fields as illustrated by the following examples and embodiments. Moreover, the present inventions would have uses and applications beyond oil, gas, geothermal and flow assurance, and would be applicable to the, cleaning, resurfacing, removal and clearing away of unwanted materials in any location that is far removed from a laser source, or difficult to access by conventional technology as well as assembling and monitoring structures in such locations. The control systems can monitor and control some, primary, preferably significant, and most preferably all major operations, parameters or conditions of such high power laser equipment, processes and activities.

In addition to directly affecting, e.g., cutting, cleaning, welding, etc., a work piece or sight, e.g., a tubular, borehole, etc., the high power laser systems can be used to transmit high power laser energy to a remote tool or location for conversion of this energy into electrical energy, for use in operating motors, sensors, cameras, or other devices associated with the tool. In this manner, for example and by way of illustration, a single optical fiber, or one or more fibers, preferably shielded, have the ability to provide all of the energy needed to operate the remote tool, both for activities to affect the work surface, e.g., cutting drilling etc. and for other activities, e.g., cameras, motors, etc. The optical fibers of the present invention are substantially lighter and smaller diameter than convention electrical power transmission cables; which provides a potential weight and size advantage to such high power laser tools and assemblies over conventional non-laser technologies. The systems can monitor and control some, primary, preferably significant, and most preferably all major operations, parameters or conditions of such high power laser equipment, processes and activities.

Photo voltaic (PV) devices or mechanical devices may be used to convert the laser energy into electrical energy. Thus, as energy is transmitted down the high power optical fiber in the form high power laser energy, i.e., high power light having a very narrow wavelength distribution it can be converted to electrical, and/or mechanical energy. A photo-electric conversion device is used for this purpose and is located within, or associated with a tool or assembly. These photo-electric conversion devices can be any such device(s) that are known to the art, or may be later developed by the art, for the conversion of light energy, and in particular laser light energy, into electrical, mechanical and/or electro-mechanical energy. Thus, for example laser-driven magnetohydrodynamic (laser MHD) devices may be used, theromphotovolatic devices may be used, thermoelectic devices may be used, photovoltaic devices may be used, a micro array antenna assembly that employs the direct coupling of photos to a micro array antenna (the term micro array antenna is used in the broadest sense possible and would include for example nano-wires, semi conducting nano-wires, micro-antennas, photonic crystals, and dendritic patterned arrays) to create oscillatory motion to then drive a current may be used, a sterling engine with the laser energy providing the heat source could be used, a steam engine or a turbine engine with the laser energy providing the heat source could be used. Such systems, apparatus and methods are disclosed and taught in U.S. patent application Ser. No. 13/374,445, the entire disclosure of which is incorporated herein by reference. The control can monitor and control some, primary, preferably significant, and most preferably all major operations, parameters or conditions of such high power laser equipment, processes and activities. High power laser systems, units, tools, conveyance structures and various applications and methods are disclosed and taught in the following US Patent Applications and US Patent Application Publications: Publication No. US 2010/0044106, Publication No. US 2010/0044105, Publication No. US 2010/0044104, Publication No. US 2010/0044103, Publication No. 2010/0044102, Publication No. US 2010/0215326, Publication No. 2012/0020631, Ser. No. 13/347,445, Ser. No. 13/210,581, Ser. No. 13/211,729, Ser. No. 13/366,882 Ser. No. 13/222,931, Ser. No. 12/896,021, Ser. No. 61/514,391, Ser. No. 61/446,407, Ser. No. 61/446,042 and Ser. No. 61/493,174, the entire disclosures of each of which are incorporated herein by reference. The systems of the present inventions may be utilized with, for, on, or in conjunction with the high power laser systems, units, tools, structures, applications and methods disclosed and taught in these forgoing patent applications. Thus, the embodiments in disclosed and taught in these foregoing patent applications may be monitored, controlled or both monitored and controlled by the systems of the present inventions. Further the various configurations, components, operations, examples and associated teachings for control systems, monitoring systems and control and monitoring systems are applicable to each other and as such configurations, components, operations and components of one embodiment may be employed with another embodiment, and combinations and variations of these, as well as, future structures and systems, and modifications to existing structures and systems based in-part upon the teachings of this specification. Thus, for example, the components, systems and operations provided in the various figures of this specification may be used with each other and the scope of protection afforded the present inventions should not be limited to a particular embodiment, configuration or arrangement that is set forth in a particular example or a particular embodiment in a particular Figure.

Many other uses for the present inventions may be developed or released and thus the scope of the present inventions is not limited to the foregoing examples of uses and applications. Thus, for example, in addition to the forgoing examples and embodiments, the implementation of the present inventions may also be utilized in laser systems for hole openers, reamers, whipstocks, and other types of boring tools.

The present inventions may be embodied in other forms than those specifically disclosed herein without departing from its spirit or essential characteristics. The described embodiments are to be considered in all respects only as illustrative and not restrictive.

What is claimed:

1. A system for controlling, operating, or monitoring, a high power laser unit having a source of high power laser energy, a high power optical conveyance device, a high power laser tool, wherein the high power optical conveyance device provides optical communication for a laser beam from the high power laser energy source to be conveyed to the high power laser tool, the system comprising:
a. a control network comprising:
i. a first monitoring device;
ii. a second monitoring device;
iii. wherein the first monitoring devices is positioned with respect to a location on the unit to detect laser energy;
iv. wherein the second monitoring device is positioned with respect to a location on the unit to detect the status of a component of the unit;
v. the first and second monitoring devices, in communication with a controller, wherein at least one of the monitoring devices can send a signal on the network; and,
vi. the controller is configured to act upon the signal from the monitoring device and performing a predetermined operation based upon the signal.

2. The system of claim 1, wherein the component is a laser tool and the signal indicates the failure of the laser tool and the operation is sending a signal to shut down the high power laser source.

3. The system of claim 1, wherein the signal is from the first or second monitoring device and the operation is to wait for a signal from the other monitoring device.

4. The system of claim 1, wherein the first monitoring device comprises a photo diode and the second monitoring device comprises a load cell.

5. The system of claim 1, wherein the component is a laser tool and the signal indicates the position of the tool.

6. The system of claim 1, wherein the component is a laser bottom hole assembly having a bit and the signal indicates the RPM of the bit.

7. A system for remotely deterring and monitoring the RPM of a down hole tool, the system comprising:
a. an accelerometer positioned in vibrational communication with a member near the top of a borehole;
b. the member in vibrational communication with a down hole tool as the tool is rotated to advance the borehole;
c. the accelerometer configured to send a signal based upon vibrations associated with the rotation of the down hole tool; and
d. a processor configured to convert the vibration signal to the RPM of the down hole tool as it is rotated to advance the borehole.

8. The system of claim 7, wherein the RPM value is utilized by a controller in the system to control the RPM of the down hole tool.

9. The system of claim 8, wherein the down hole tool is a laser bottom hole assembly.

10. A control system for a high power laser unit for performing a laser operation at a remote location, the system and unit comprising:
a. a first module in communication with a source of high power laser energy, the laser source capable of providing a laser beam having at least 5 kW of power;
b. a second module in communication with a tubing assembly, the tubing assembly comprising: a tubing having a distal end and a proximal end, and a high power optical fiber having a distal end and a proximal end, wherein the high power optical fiber is associated with the tubing and the high power optical fiber distal end is associated with the tubing distal end;
c. a third module in communication with a high power laser tool, the laser tool in optical association with the distal end of the high power fiber and in mechanical association with the distal end of the tubing;
d. a fourth module in communication with a motive means, the motive means to advancing the distal end of the tubing to a predetermined worksite location;
e. the proximal end of the optical fiber in optical association with the laser source, whereby the laser beam can be transmitted from the laser source to the laser tool;
f. a fifth module in communication with a human machine interface; and,
g. a control module in communication with the first, second, third, fourth and fifth modules;
h. whereby, the control module is configured to send a control signal to send a control signal to at least one of the first, second, third, or fourth modules based upon a signal received from at least one of the first, second, third, fourth or fifth modules, to thereby control an operation of the unit.

11. The system and unit of claim 10, wherein the control module is associated with a programmable logic controller.

12. The system and unit of claim 11, wherein the control module is associated with a personal computer.

13. The system and unit of claim 10, wherein the tubing is selected from the group consisting of composite tubing, coiled tubing and wireline; wherein the optical fiber has a length selected from the group consisting of about 0.5 km, about 1 km, about 2 km, about 3 km and from about 0.5 km to about 5 km; and wherein the laser tool is selected from the group consisting of a laser cutting tool, a laser bottom hole assembly and an electric motor laser bottom hole assembly.

14. The system and unit of claim 10, wherein the first, third and control modules reside on a control network, the network and modules configured to send and receive data signals and control signals between the first, third and control modules.

15. The system and unit of claim 11, wherein the second, fourth and fifth modules reside on the control network and the network and modules configured to send and receive data signals and control signal between the second, fourth, fifth and control modules.

16. The system and unit of claim 10, wherein a signal is received from the fifth module causing the control to send a signal to the third and fourth modules to stop operation of the tool, and retrieve the tool.
